(19) United States
(12) Patent Application Publication
(10) Pub. No.: US 2026/0291971 A1
(43) Pub. Date: Sep. 24, 2026

(54) SYSTEM

(71) Applicant: SoftBank Group Corp., Tokyo (JP)

(72) Inventor: Shihori KITANO, Tokyo (JP)

(73) Assignee: SoftBank Group Corp., Tokyo (JP)

(21) Appl. No.: 19/562,876

(22) Filed: Mar. 11, 2026

(30) Foreign Application Priority Data
Mar. 19, 2025 (JP) 2025-044967

(51) Int. Cl. H04L 9/40

(52) U.S. Cl. CPC H04L 63/1425; H04L 63/1441

(57) ABSTRACT

A system includes a processor that is configured to: generate a first prompt for instructing a generative AI model to analyze contents of suspicious communications received by an elderly user and to evaluate a likelihood of fraud, input the first prompt into the generative AI model and obtain, from the generative AI model, an evaluation of the likelihood of fraud with respect to the contents of the suspicious communications, and generate a second prompt for instructing the generative AI model to analyze suspicious information provided by the elderly user and to determine whether the suspicious information is related to fraud.

### CROSS-REFERENCE TO RELATED APPLICATION

This application is based on and claims priority under 35 USC 119 from Japanese Patent Application No. 2025-044967 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Elderly users are frequently targeted by fraudulent schemes conducted through various communication channels such as telephone calls, emails, text messages, and online links. Conventional security systems generally rely on fixed rule-based filters, blacklists, or simple keyword detection. These conventional systems are often unable to cope with rapidly evolving fraud patterns that use natural and variable language expressions designed to evade static detection rules. In addition, conventional interfaces are not optimized for elderly users, who may have difficulty understanding complex warning messages or technical security terminology. As a result, elderly users may fail to recognize suspicious communications or information as fraudulent and may not receive timely, understandable, and concrete warnings or guidance. Therefore, there is a need for a system that dynamically utilizes generative AI models to analyze suspicious communications and information received or provided by elderly users, to evaluate the likelihood of fraud, to extract important indicators such as keywords, and to generate warning messages in an easily understandable form, thereby supporting elderly users in protecting themselves from fraud.

### SUMMARY

In order to solve the foregoing problems, a system is provided that comprises a processor configured to cooperate with a generative AI model by means of a series of prompts. The processor is configured to generate a first prompt for instructing the generative AI model to analyze contents of suspicious communications received by an elderly user and to evaluate a likelihood of fraud, and to input the first prompt into the generative AI model so as to obtain, from the generative AI model, an evaluation of the likelihood of fraud with respect to the contents of the suspicious communications. The processor is further configured to generate a second prompt for instructing the generative AI model to analyze suspicious information provided by the elderly user and to determine whether the suspicious information is related to fraud. In addition, the processor is configured to generate a third prompt for instructing the generative AI model to analyze the contents of the suspicious communications and to extract important keywords, and to input the third prompt into the generative AI model to cause the generative AI model to perform analysis and extraction of the important keywords. Furthermore, the processor is configured to generate a fourth prompt for instructing the generative AI model to generate a warning message, based on an evaluation result of the likelihood of fraud, for provision to the elderly user visually or auditorily, and to generate the warning message by using the fourth prompt. By flexibly controlling the generative AI model through these prompts, the system can dynamically adapt to new fraud patterns, provide detailed yet simple explanations and warnings tailored to elderly users, and thereby effectively support the elderly user in recognizing and avoiding fraudulent communications and information.

The term “system” refers to an arrangement including at least one processor and one or more associated hardware or software components that cooperate to perform the functions described in the claims.

The term “processor” refers to any hardware component or combination of components capable of executing instructions, including but not limited to a central processing unit (CPU), a microprocessor, a microcontroller, a digital signal processor (DSP), a graphics processing unit (GPU), or a dedicated AI accelerator, and also encompasses multiple processors operating in cooperation.

The term “generative AI model” refers to a machine learning model configured to generate output data, such as text, in response to input data, and includes, for example, large language models and other generative models that can analyze input content, infer meanings or patterns, and produce evaluation results, explanations, or messages.

The term “prompt” refers to input data, including instructions, questions, templates, or contextual information, that is supplied to the generative AI model in order to cause the generative AI model to perform a specific analysis, evaluation, extraction, or generation task.

The term “suspicious communications” refers to communications received by an elderly user, including but not limited to emails, text messages, instant messages, social media messages, or telephone call transcripts, that may potentially be associated with fraudulent activities.

The term “suspicious information” refers to information provided by an elderly user, including but not limited to URLs, links, message texts, or details of a phone call, that the elderly user considers or suspects may be related to fraud.

The term “likelihood of fraud” refers to a degree or probability, which may be expressed qualitatively or quantitatively, indicating how probable it is that a given communication or information is associated with fraudulent activity.

The term “important keywords” refers to words, phrases, or other text segments extracted from the contents of suspicious communications that are indicative of fraud-related patterns, such as terms expressing urgency, requests for payment, demands for credentials, or references to financial or personal information.

The term “warning message” refers to a message generated for presentation to an elderly user that indicates a risk of fraud associated with a communication or information, and that may include an explanation, a risk assessment, or guidance on recommended actions.

The term “visually or auditorily” refers to modalities for presenting information to an elderly user, including at least one of a visual presentation such as text or graphics on a display and an auditory presentation such as speech output or sound alerts via a speaker or audio device.

The term “elderly user” refers to a user belonging to an older age group, such as a senior citizen, who may have reduced familiarity with digital technologies or increased vulnerability to fraudulent communications, and for whom the system is primarily intended to provide protection and assistance.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

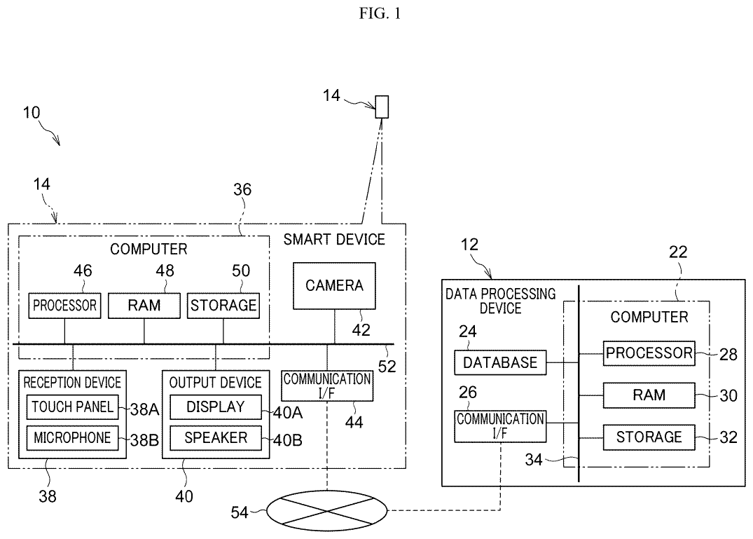

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

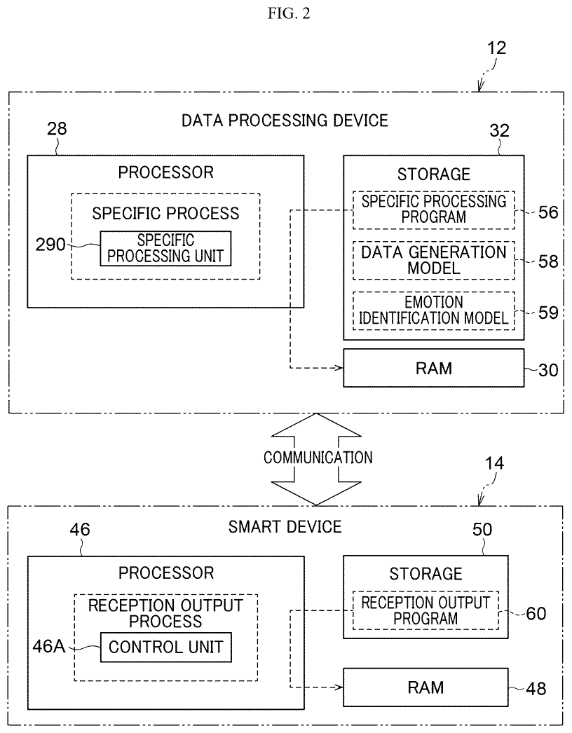

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented systems for detecting fraudulent communications are typically designed as static rule-based filters or as generic text classifiers that output a simple binary label. Such systems suffer from several technical limitations when applied to suspicious communications received by elderly users. First, known systems tend to process input text in a monolithic manner, without a structured pipeline of normalization, feature extraction, and prompt conditioning tailored to a generative AI model. As a result, the input to the underlying models often contains noise, redundant symbols, and uninformative tokens, which degrades the accuracy and stability of fraud-risk evaluation and increases computational overhead.

Second, conventional systems that incorporate machine learning models, including generative AI models, generally accept unstructured prompts that are manually designed and not dynamically adapted to the characteristics of each communication. This lack of systematic prompt construction prevents the model from focusing on salient fraud-relevant features such as urgency, financial terms, or contact instructions. Consequently, the model's internal resources are not efficiently utilized, leading to suboptimal fraud detection performance and inconsistent explanations across different messages.

Third, existing approaches do not tightly integrate user-specific feedback, especially feedback from elderly users or their representatives, into the technical operation of the fraud detection pipeline. In many systems, feedback is either ignored or used only at an application level without technically updating the model interface, such as prompt content, or numerical thresholds in the risk-scoring logic. This results in a static system that cannot be progressively adapted to evolving fraud patterns or to the comprehension level and behavior of the target user population.

Fourth, conventional notification mechanisms often provide generic alerts that are not derived from the internal evaluation process of the model and are not adapted to an elderly user's comprehension level or preferred modality. Such alerts can be overly technical, ambiguous, or visually and auditorily inadequate, which increases cognitive burden and reduces the practical effectiveness of fraud warnings. Moreover, these systems typically do not exploit the generative capabilities of modern AI models to generate explanations and user-tailored warnings in a controlled and verifiable manner.

Therefore, there is a need for an improved computer-implemented system that: (i) preprocesses suspicious communication text into a structured language representation, (ii) extracts fraud-relevant feature data and incorporates this data into a well-formed prompt sentence for a generative AI model, (iii) converts the model's output into a numerical risk index and multi-level classification using defined thresholds, and (iv) generates notifications and warning messages optimized for elderly users, while (v) technically integrating user feedback to update at least the prompt content and risk thresholds. Such improvements address technical problems in how computers represent, process, and utilize textual communication data for fraud-risk assessment and user notification.

The specific processing by the specific processing unit 290 of the data processing device 12 in Example 1 is realized by the following means.

The present invention provides a server comprising a processor configured to acquire, from a terminal, character information representing a suspicious communication received by an elderly user, perform machine-based preprocessing on the character information including at least normalization, symbol removal, segmentation, and word-form normalization to generate language data suitable for subsequent analysis, execute feature extraction on the language data to generate feature data including words and phrases potentially related to fraud, construct a prompt sentence that explicitly embeds the language data and the feature data and instructs a generative AI model to evaluate a likelihood of fraud, input the prompt sentence into the generative AI model and obtain, from the generative AI model, evaluation information including a fraud-risk assessment and explanatory information, convert the fraud-risk assessment and the feature data into a numerical index and classify the suspicious communication into one of a plurality of risk categories based on the numerical index, generate a warning message for the elderly user based at least on the risk category and the explanatory information, cause the terminal to present the warning message to the elderly user via at least one of a visual output and an audio output, and acquire feedback information from at least one of the elderly user and a representative via the terminal and update at least one of the prompt sentence content and a threshold used for classification of the numerical index based on the feedback information. This enables technical improvement of computer-based fraud detection and notification by structuring textual inputs into feature-aware prompts for a generative AI model, by converting unstructured model outputs into calibrated numerical risk indices and multi-level classifications, and by adaptively refining prompt design and threshold parameters through feedback-driven updates, thereby increasing processing efficiency, detection accuracy, and usability for elderly users.

The term “processor” refers to a hardware-based information processing unit, such as a central processing unit or an execution core, configured to execute program instructions to perform the operations described in the present disclosure.

The term “terminal” refers to an information processing apparatus operated by a user, such as a portable communication device, a personal computer, or an electronic display device, that is configured to transmit and receive data to and from a server.

The term “elderly person” refers to a human end user belonging to an age group for which support in understanding and handling electronic communications is desired, and who is the intended recipient of suspicious communications analyzed by the system.

The term “suspicious communication” refers to electronic communication content, such as an electronic mail, a text message, an application message, or a web-based notification, that may potentially involve fraudulent or deceptive activity.

The term “character information” refers to digital data representing natural-language content of a suspicious communication in the form of encoded characters or strings, suitable for processing by an information processing apparatus.

The term “communication path” refers to a logical or physical communication channel, such as a wired or wireless network connection, used for transmitting data between the terminal and the server.

The term “input data” refers to data received by the server from the terminal, including at least character information representing the suspicious communication to be analyzed.

The term “preprocessing” refers to a series of machine-executed operations applied to input data, including at least normalization of characters, removal of unnecessary symbols, segmentation into linguistic units, and normalization of word forms, to obtain language data suitable for analysis.

The term “language data” refers to data representing textual content after preprocessing, including information such as normalized text, tokens, or structured linguistic elements that can be used for further analysis and feature extraction.

The term “feature data” refers to data representing extracted properties or attributes of the language data, including at least words and phrases potentially related to fraud, and optionally including frequencies, positions, or other indicators derived from the language data.

The term “partial structural analysis” refers to a machine-executed operation that analyzes the internal structure of the language data, including relationships between words and phrases, in order to identify meaningful units and dependencies.

The term “occurrence frequency calculation” refers to a process of determining how often particular words or phrases appear within the language data, and generating numerical values representing such frequencies.

The term “generative AI model” refers to a machine-learned information processing model that, in response to an input including a prompt sentence, generates output data such as natural language text, evaluations, or classifications based on learned statistical patterns.

The term “prompt sentence” refers to a machine-generated or predefined text string that is provided as input to a generative AI model and that specifies an instruction, context, and related data, including at least the language data and the feature data, to cause the generative AI model to perform a desired evaluation or generation task.

The term “fraud risk” refers to a likelihood or degree of probability that a given suspicious communication is associated with fraudulent or deceptive activity, as determined by the system.

The term “evaluation result” refers to information generated by the generative AI model or by subsequent processing, including at least an assessment of fraud risk for the suspicious communication.

The term “explanatory information” refers to data indicating reasons or factors that support the evaluation result, including but not limited to textual explanations describing which elements of the suspicious communication contributed to the fraud-risk assessment.

The term “numerical index” refers to a numeric value representing a quantified measure of fraud risk, derived from the evaluation result and optionally from the feature data, and used for classification of the suspicious communication.

The term “risk category” refers to one of a plurality of predefined classes or levels, such as low, medium, or high, indicating the degree of fraud risk associated with the suspicious communication, determined based on the numerical index.

The term “warning message” refers to output data generated by the server that includes warning content for an elderly person, such as guidance or cautions regarding the suspicious communication, and that is configured to be presented by the terminal.

The term “notification” refers to a process or state in which the warning message is presented to the elderly person through at least one output modality, such as visual display or audio output, via the terminal.

The term “visual output” refers to presentation of information by a display device, such as a screen or monitor, in a human-readable visual form, including text, symbols, or graphical elements.

The term “audio output” refers to presentation of information as sound, such as synthesized speech or alert tones, via an audio output device associated with the terminal.

The term “feedback information” refers to information obtained from at least one of the elderly person and a representative, indicating a user's response, confirmation, correction, or evaluation regarding whether the suspicious communication is actually fraudulent or non-fraudulent.

The term “representative” refers to a person other than the elderly person, such as a caregiver, family member, or trusted assistant, who is authorized to provide feedback information or operate the terminal on behalf of the elderly person.

The term “storage unit” refers to a data storage component, such as a memory device or a storage device, configured to store reference information, feature data, evaluation results, feedback information, or threshold values used in the system.

The term “reference information” refers to data stored in the storage unit that defines words, phrases, or patterns potentially related to fraud, and that is used as a basis for comparison during feature extraction.

The term “threshold value” refers to a numerical boundary used in connection with the numerical index to determine transitions between different risk categories or to trigger generation of particular types of warning messages.

The term “learning assistance” refers to a process in which feedback information is used to update at least one system parameter, such as prompt sentence content or the threshold value, so as to adapt the operation of the system to actual user behavior and evolving fraud patterns.

In one embodiment, a server executes a computer program on a hardware platform that includes at least one processor, a main memory, a nonvolatile storage device, and a network interface. The server runs an operating system such as a general-purpose server operating system, and an application layer implemented, for example, in a programming language such as Python. The server loads software libraries for natural language processing, such as a general-purpose NLP toolkit and a syntactic analysis library, and communicates with a generative AI model implemented as a large-scale neural network. The server stores configuration data, reference dictionaries, fraud-related patterns, and user feedback data in a database system such as a relational database.

The terminal operates as a client apparatus, such as a smartphone, a tablet, or a personal computer, executing an application that provides a graphical user interface to a user. The terminal includes a display, an audio output unit, an input device, a memory, and a communication interface. The terminal runs an application that is implemented, for example, using a mobile application framework or a web browser, and that is configured to send text data representing suspicious communications to the server and to present warning messages received from the server. The user operates the terminal to input suspicious communications and to provide feedback regarding analysis results.

The server implements a data processing pipeline that is realized as a set of cooperating software modules. A communication module of the server receives from the terminal text data representing a suspicious communication. The text data is represented as a character string encoded in a character encoding format such as UTF-8, and is encapsulated in a structured data object that includes fields such as message text, language code, and user identifier. The server stores the raw text and associated metadata in a storage structure, such as a table of a relational database, together with a timestamp and a unique analysis identifier.

The server executes a preprocessing module that performs linguistic normalization on the received text. The preprocessing module uses the NLP libraries to apply operations such as lowercasing, deletion of non-informative symbols, normalization of whitespace, and, where appropriate, conversion of full-width characters to half-width characters. The server further uses tokenization algorithms provided by the NLP libraries to segment the text into a sequence of tokens, each token representing a word, punctuation mark, or symbol. The server additionally applies lemmatization to convert inflected word forms to canonical forms and may remove stop words defined in a stop-word list. As a result, the server generates language data that includes at least a normalized text string, a token list, a lemma list, and statistical attributes such as token count and sentence boundaries.

The server executes a feature extraction module that performs partial structural analysis on the language data. The server invokes part-of-speech tagging and dependency parsing using the NLP libraries. The server identifies noun phrases, verb phrases, and dependency relations that correlate with known fraud patterns, such as demands for urgent action, references to financial accounts, or requests for credentials. The server compares tokens and phrases against reference information stored in a storage unit, including lists of fraud-related keywords, regular expression patterns for phone numbers, financial account identifiers, and hyperlinks, and templates that describe common scam structures. The server generates feature data that contains, for each analyzed message, at least a set of matched keywords, phrase types, positions of matches in the text, counts of specific entity types, and binary or numerical indicators representing the presence of risk-enhancing attributes such as urgency or monetary requests.

The server constructs a prompt sentence to be provided as input to the generative AI model. The server encodes the language data and the feature data into a human-readable text format that is structured but not in a machine-specific serialization format. The server places an instruction portion at the beginning of the prompt sentence, a context portion including the extracted keywords and features, and a message portion including the normalized text of the suspicious communication. The instruction portion specifies, in natural language, the evaluation task required from the generative AI model, the output format, and the risk levels to be used. An example of a prompt sentence constructed by the server is:

“You are a security assistant helping elderly users. Analyze the following message and evaluate the likelihood that it is a fraud or phishing attempt. Use the extracted keywords and contextual information to decide. Return three items in plain text: (1) a risk level as ‘low’, ‘medium’, or ‘high’; (2) a brief explanation in simple language; and (3) a one-sentence warning suitable for an elderly user. Extracted keywords and features: bank account; unauthorized use; urgent request; phone number present. Message: ‘Your bank account has been used fraudulently. Contact us immediately at the number below.’”

The server transmits the constructed prompt sentence to the generative AI model. In one embodiment, the generative AI model is provided by an inference service that executes on a separate computing device including one or more accelerators such as graphics processing units. The generative AI model is implemented, for example, as a transformer-based neural network possessing multiple encoder-decoder layers, self-attention mechanisms, and feedforward sublayers. The model has been pre-trained on a large corpus of text using a self-supervised objective such as next-token prediction or masked-token prediction, and optionally fine-tuned on instruction-following data. The server supplies the prompt sentence as input tokens to the model. The model internally computes attention weights over the token sequence, applies matrix multiplications with learned weight matrices, computes non-linear activation functions, and produces a sequence of output tokens representing a textual response.

The server receives the response from the generative AI model and parses the response using string processing routines. The server identifies portions corresponding to the risk level, the explanation, and the one-sentence warning. In one embodiment, the server enforces a response protocol by including in the prompt sentence explicit markers or labels that the model is instructed to use, which facilitates robust parsing. The server then converts the qualitative risk level into a numerical index by mapping, for example, “low” to a lower numeric value, “medium” to an intermediate value, and “high” to a larger value. The server may further adjust the numerical index based on the feature data, such as increasing the index when multiple high-risk keywords and patterns are present or when structural indicators of fraud, such as mismatched sender identity and content, are detected.

The server classifies the suspicious communication into one of a plurality of risk categories using threshold values stored in the storage unit. The server compares the numerical index with lower and upper thresholds. For example, if the index is greater than or equal to an upper threshold, the server assigns a “high risk” category; if the index lies between lower and upper thresholds, the server assigns a “suspected risk” category; and if the index is below the lower threshold, the server assigns a “low risk” category. The server further determines a fraud type category, such as banking fraud, account phishing, or prize scam, based on the feature data and the content of the explanation obtained from the generative AI model. The server stores the numerical index, the risk category, and related data in the database.

The server generates a warning message that is specifically adapted to elderly users. The server uses template-based generation logic that selects a base template according to the risk category and then combines the template with the warning sentence and explanation derived from the generative AI model. For a high-risk communication, the server may generate a warning message such as: “This message is very likely to be a fraud. Do not respond to the message, do not call any phone number in the message, and do not enter any personal or financial information.” The server ensures that the message is expressed in simple, clear language without technical jargon, and may adjust the length so as not to overwhelm the user. The server then transmits the warning message and the associated risk information to the terminal.

The terminal presents the warning message to the user. The terminal displays the warning text on the display in a large font size and may use color coding to emphasize urgency. The terminal further uses its audio output unit and a text-to-speech engine to read the warning aloud, thereby assisting users with impaired vision or reading difficulties. The terminal can show, in addition to the warning message, a simplified explanation such as “The message asks you to act urgently about your bank account, which is a common sign of fraud.” The terminal enables the user or a representative to provide feedback by selecting options such as “This was a real fraud” or “This was not fraud.” The terminal sends the feedback information to the server.

The server receives feedback information and stores it in association with the corresponding analysis identifier, numerical index, and classification result. The server uses the accumulated feedback data to update system parameters. In one embodiment, the server analyzes the distribution of numerical indices for messages confirmed as fraud and non-fraud and adjusts the threshold values to reduce classification errors. In another embodiment, the server identifies cases where the generative AI model's explanation repeatedly fails to match user feedback and modifies the prompt sentence templates to more strongly emphasize or de-emphasize certain types of features. For example, the server may change the instruction portion of the prompt sentence to require the model to pay particular attention to monetary transfer requests or to de-emphasize generic greetings that are not strongly correlated with fraud.

The server thereby implements a feedback-driven optimization loop that is executed entirely by machine resources. Because the server automatically refines prompt sentence templates and threshold values based on aggregated feedback, the system adapts to evolving fraud patterns and user behavior in a manner that is not limited to static human-designed rules. This adaptation mechanism leads to improved fraud detection accuracy and reduced false positives and false negatives over time.

From a technical perspective, the server's structured pipeline, combination of deterministic feature extraction with generative model conditioning, and feedback-based parameter updates provide improvements to computer technology. The decomposition of input processing into normalization, tokenization, structural analysis, and feature extraction reduces noise and decreases the number of tokens required to be processed by the generative AI model, which improves processing speed and reduces memory usage. The explicit embedding of feature data into the prompt sentence focuses the model's attention on relevant portions of the text, improving the model's effective utilization of its internal parameters and increasing the stability and reproducibility of risk evaluations. The conversion of unstructured model output into a numerical index with defined thresholds enables the server to perform coherent, machine-implementable decision-making that can be calibrated and optimized, rather than relying on ad hoc interpretation of texts.

Furthermore, the server and terminal together provide a concrete technical application that interacts with real communication channels and user interfaces. The system operates on actual communication data transmitted over network infrastructure, controls the display and audio output devices of the terminal to present warnings, and manages persistent storage of analysis results and feedback. The processing sequence is optimized to reduce redundant transmissions and to compress the relevant information into compact feature representations, thereby contributing to communication load reduction. In addition, by integrating the generative AI model through structured prompt sentences and post-processing of outputs, the server uses the model not merely as a black box but as a component in a defined algorithmic pipeline that can be analyzed, tuned, and improved.

In an alternative embodiment, the server employs a different generative AI model architecture, such as a recurrent neural network with attention or a hybrid model incorporating convolutional layers for character-level processing. The server may also adopt different learning methods, such as supervised fine-tuning using labeled fraud datasets or reinforcement learning from feedback signals. The loss function used during training can include a cross-entropy term for next-token prediction combined with an auxiliary loss reflecting correct classification of fraud risk. The model's weights are adjusted by gradient descent-based algorithms such as stochastic gradient descent with momentum or adaptive optimization methods. Although the training phase may occur outside the deployed system, the deployed server can still adjust behavior by modifying prompt sentences, selecting different model variants, or altering feature importance weights.

In another embodiment, the feature extraction module operates with a more extensive set of features, such as character n-grams, syntactic pattern counts, sentiment scores, and anomaly scores derived from statistical language models. The server may use a separate, lightweight classifier such as a logistic regression model or a gradient-boosted tree model that consumes the feature data and the generative AI model's qualitative risk output to compute the numerical index. The server then uses the numerical index in the same way to classify the communication and generate warnings. This hybrid architecture further enhances robustness because the system combines complementary strengths of symbolic rule-based features, classical statistical models, and generative neural models.

In still another embodiment, the terminal performs a subset of preprocessing operations locally, such as basic normalization and token counting, to reduce the volume of data transmitted to the server and thus decrease network bandwidth usage. The server in such a case can omit redundant preprocessing steps and directly consume partially normalized data. The functional allocation between the server and the terminal can be adjusted depending on available computational resources and network conditions.

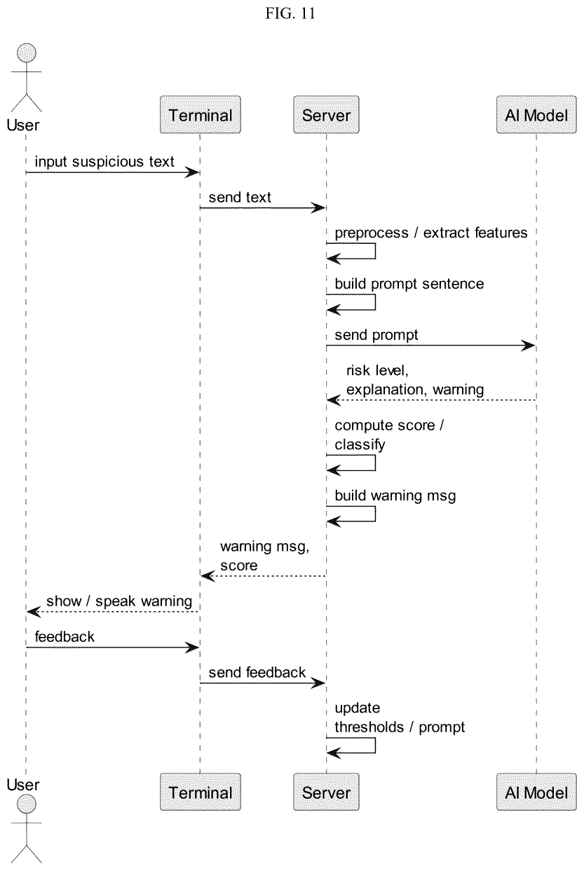

The system, as described in these embodiments, provides a specific technical solution to the problem of accurately and efficiently evaluating fraud risk in communications received by elderly users and delivering comprehensible warnings. By organizing the processing into modules that manipulate concrete data structures and by employing a generative AI model within a carefully designed prompt-and-response protocol, the server improves the precision, speed, and resource utilization of fraud detection beyond mere manual inspection or generic text classification. The interaction between the server and terminal brings the analysis results into the physical world through controlled operation of display and audio hardware, thereby completing a technical loop from data acquisition, through structured computational analysis, to user-oriented output and feedback-based adaptation.
The following describes the processing flow using FIG. 11.

### Step 1:

The user operates the terminal to input a suspicious communication.
The user enters, into an input field of an application running on the terminal, text such as an email body, a short message, or an in-app message received by an elderly person.
The terminal receives the raw text as input and converts it into a character string encoded in UTF-8.
The terminal generates a structured data object that includes at least the fields “message_text”, “language_code”, and a user or device identifier.
The terminal outputs this structured data object as request data destined for the server.

### Step 2:

The terminal transmits the request data to the server.
The terminal takes the structured data object as input and encapsulates it into an HTTP request sent over a secure communication protocol.
The terminal attaches authentication information such as a session token to the header and sets a target endpoint address of the server.
The terminal outputs the HTTP request containing the structured data object as network data on a communication path.

### Step 3:

The server receives the network data and performs request validation.
The server takes as input the HTTP request and decodes the body to reconstruct the structured data object.
The server checks that mandatory fields such as “message_text” and “language_code” are present and verifies that the size of the text does not exceed a predefined limit.
The server removes control characters and suspicious escape sequences from the input to prevent injection attacks.
The server outputs a sanitized text string, the language code, and associated metadata as validated input data for subsequent processing.

### Step 4:

The server performs text normalization and tokenization.
The server takes the validated text string as input and applies normalization operations, including lowercasing, normalization of whitespace, unification of character variants, and removal of non-informative symbols.
The server uses natural language processing libraries to segment the normalized string into tokens representing words and punctuation, and applies lemmatization to convert inflected forms to canonical forms.
The server calculates basic statistics such as character length, token count, and number of sentences.
The server outputs language data that includes a normalized text string, a token list, a lemma list, and statistical attributes.

### Step 5:

The server executes structural analysis and feature extraction.
The server takes the language data as input and performs part-of-speech tagging and dependency parsing using an NLP engine.
The server detects noun phrases and verb phrases that match predefined fraud-related patterns stored in a reference table, such as phrases indicating urgency, money transfer, or verification of credentials.
The server scans the tokens and phrases against keyword lists and regular expressions that describe contact information, financial entities, and hyperlinks.
The server assigns numerical values to extracted properties, such as counts of high-risk terms, number of contact items, and presence flags for specific patterns.
The server outputs feature data consisting of matched keywords and phrases, their positions, count values, and binary indicators that summarize fraud-related characteristics of the message.

### Step 6:

The server constructs a prompt sentence for a generative AI model.
The server takes the normalized text and the feature data as input and composes a natural-language instruction that describes the evaluation task, required output items, and risk levels.
The server embeds extracted keywords, pattern indicators, and simplified message content into the prompt sentence to provide context to the generative AI model.
The server formats the prompt sentence as a single text string that begins with instructions, followed by a list of key features, and finally the message text.
The server outputs the constructed prompt sentence as model input data.

### Step 7:

The server transmits the prompt sentence to the generative AI model and obtains a textual response.
The server takes the prompt sentence as input and converts it into a sequence of tokens using a tokenizer associated with the generative AI model.
The server sends these tokens to a model execution environment that runs a neural network model, such as a transformer-based language model, which applies matrix multiplications, attention computations, and non-linear activations to generate output tokens.
The model returns a sequence of output tokens that the server decodes into a response text string containing at least a risk level, an explanation, and a warning expression.
The server outputs the response text as model output data.

### Step 8:

The server parses the model output and derives a risk index.
The server takes the model output text as input and applies string parsing rules to identify segments that correspond to the risk level, the explanation, and the warning expression.
The server maps textual risk levels such as “low”, “medium”, and “high” to numeric values according to a predefined scale, and optionally adjusts these values based on the feature data (for example, increasing the value when multiple high-risk features are present).
The server computes a single numerical index that represents the fraud risk by aggregating the mapped value and any adjustments.
The server outputs the numerical index, the parsed risk level, and the explanation as evaluated risk data.

### Step 9:

The server classifies the suspicious communication into risk categories.
The server takes the numerical index as input and compares it to threshold values stored in a configuration store.
The server determines, based on the comparison, whether the communication falls into categories such as low risk, suspected risk, or high risk.
The server may also derive a fraud type classification by matching keywords and explanation content against category-specific rules.
The server outputs a classification result containing the risk category, any fraud type label, and the numerical index.

### Step 10:

The server generates a warning message for the elderly user.
The server takes as input the classification result, the explanation text, and the warning expression from the model output.
The server selects a message template that corresponds to the risk category and inserts the warning expression and simplified explanation into designated positions in the template.
The server modifies sentence structure and vocabulary to ensure that the message is understandable to an elderly user, for example by avoiding technical terms and using short sentences.
The server outputs a finalized warning message text together with associated risk information as notification data.

### Step 11:

The server delivers the notification data to the terminal.
The server takes the warning message text, risk level, and numerical index as input and constructs a structured response object.
The server encapsulates this response object into an HTTP response and transmits it back to the terminal over the communication path.
The server may also record the notification data and analysis identifiers in persistent storage for logging and later reference.
The server outputs the HTTP response as network data addressed to the terminal.

### Step 12:

The terminal presents the warning message to the user.
The terminal takes the HTTP response as input and parses the structured response object to extract the warning message text and risk-related values.
The terminal displays the warning message on the screen, adjusting font size, colors, and layout to enhance readability, and may emphasize high-risk warnings with prominent visual cues.
The terminal uses an audio subsystem and a text-to-speech engine to convert the warning message into speech and emits the audio through a speaker so that the elderly user can hear the warning.
The terminal outputs a user-visible and/or user-audible representation of the warning message.

### Step 13:

The user provides feedback based on the presented warning.
The user views or listens to the warning message on the terminal and determines whether the communication was actually fraudulent or legitimate.
The user selects a feedback option presented on the terminal, such as “This was fraud” or “This was not fraud,” or inputs additional comments through the user interface.
The terminal receives the selected option and any comments as input and packages them into feedback data that includes the analysis identifier and feedback label.
The terminal outputs the feedback data as a structured object destined for the server.

### Step 14:

The terminal transmits the feedback data to the server.
The terminal takes the feedback data as input and incorporates it into an HTTP request addressed to a feedback endpoint of the server.
The terminal sends this request over the communication path and may display a short status indicator to the user while transmission is in progress.
The terminal outputs the HTTP request containing the feedback data as network data to the server.

### Step 15:

The server updates system parameters based on the feedback data.
The server takes the feedback data as input and stores it in association with the corresponding analysis identifier, numerical index, and classification in a feedback table.
The server analyzes aggregated feedback to compute updated statistics, such as the distribution of indices for true fraud versus non-fraud, and recalculates threshold values that separate risk categories in order to reduce misclassification.
The server examines patterns where the generative AI model's explanations conflict with user feedback and modifies the prompt sentence templates or feature weighting rules so that future prompts emphasize discriminative features and de-emphasize misleading ones.
The server outputs updated configuration parameters, including revised threshold values and prompt sentence templates, which are then used as new inputs in subsequent analyses.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional fraud-detection techniques for suspicious communications received by elderly users generally rely on static keyword lists, rigid pattern-matching rules, or simple statistical models executed on general-purpose computing hardware. These approaches suffer from several technical limitations. First, rule-based filters frequently generate false positives and false negatives because they cannot sufficiently capture the contextual nuances of natural language used in fraudulent messages, such as socially engineered urgency, obfuscated requests for confidential data, or cleverly disguised references to financial institutions. Second, conventional systems often treat natural language processing and risk evaluation as separate, loosely coupled stages, which leads to inefficient use of computing resources and inconsistent results when the extracted features do not align with the risk-scoring logic. Third, known systems generally lack a flexible mechanism for dynamically expressing analysis intent to advanced generative models in a machine-optimized format, resulting in suboptimal interaction with such models and increased computational overhead due to poorly structured inputs.

Moreover, existing architectures do not effectively integrate outputs from generative models with deterministic rule-based analysis executed on server-side computing resources. In many deployments, the generative model is used either as the sole decision source or merely as an auxiliary advisor, without a clearly defined algorithm for combining model-derived numerical indicators with rule-derived scores. This can cause instability, reduced reproducibility of results, and difficulty in tuning the system for different classes of fraudulent behavior. In addition, conventional systems frequently provide only generic warnings to end users, without leveraging detailed internal analysis results to construct targeted alerts that match the actual fraud patterns detected in the communication content.

From a computer-technology perspective, there is a need for a server-centric processing scheme that structurally improves how textual communication data is represented, analyzed, and evaluated with respect to fraud risk. Specifically, it is desirable to implement a mechanism in which a processor on a server: (i) performs structured natural language preprocessing to derive feature information indicating fraud-related patterns; (ii) generates prompt sentences that encode both the original character information and the derived feature information as machine-readable analysis instructions for a generative AI model; (iii) obtains a numerical fraud risk index and explanatory information from the model; and (iv) combines such index with rule-based evaluation values in a deterministic manner to compute a comprehensive fraud risk value. Furthermore, there is a need to technically integrate such comprehensive risk evaluation with a server-controlled notification pipeline toward a communication terminal, so that alerts can be generated and presented in a form appropriate to the elderly user, including visual and auditory modalities, while maintaining efficient and repeatable processing on the server side.

Accordingly, the technical problem to be solved by the present invention is to improve the computer-implemented processing of suspicious communication data by providing an architecture and processing method that: enhances the accuracy and robustness of fraud risk evaluation in natural language communications; optimizes the interaction between server-side natural language processing and a generative AI model through structured prompt generation; deterministically integrates model-based and rule-based evaluations into a comprehensive risk score; and automatically produces context-aware, device-ready warning information for elderly users via a communication terminal, thereby improving the overall efficiency and reliability of fraud detection in computer systems.

The specific processing by the specific processing unit 290 of the data processing device 12 in Application Example 1 is realized by the following means.

The present invention provides a server comprising a processor and a memory storing instructions that, when executed by the processor, cause the processor to receive communication content acquired from a communication terminal and store the communication content as character information, perform tokenization processing and information extraction processing on the character information by using a natural language processing resource to obtain feature information including expressions that are potentially related to fraud, generate a prompt sentence including evaluation instruction content for evaluating a possibility of fraud based on the feature information and the character information and input the prompt sentence to a generative AI model to obtain evaluation information relating to fraud risk, calculate a comprehensive fraud risk value by using the evaluation information and the feature information and determine a danger level classification of the communication content based on the comprehensive fraud risk value, generate notification information including warning content based on the evaluation information and the feature information when the danger level classification satisfies a predetermined condition and transmit the notification information to the communication terminal, and control presentation of a warning to an elderly user via a visual output device or an auditory output device of the communication terminal based on the notification information. This enables a computer-implemented fraud-detection process in which server-side resources systematically convert raw communication data into structured feature information, interact with a generative AI model through optimized prompt sentences to obtain a numerical fraud risk index and explanatory information, deterministically integrate model-based and rule-based evaluations into a comprehensive risk score, and automatically deliver context-aware warning information to a communication terminal for presentation to an elderly user, thereby improving the technical performance, accuracy, and reliability of fraud detection in natural language communications processed by the server.

The term “communication content” refers to data representing information exchanged between parties via a communication medium, including but not limited to email messages, text messages, voice-call transcripts, and similar message bodies, which are acquired from a communication terminal and provided to a server for processing.

The term “communication terminal” refers to an electronic apparatus operated by a user, such as a mobile device, a tablet device, a personal computer, or a similar user-end device, that acquires communication content and transmits the communication content or related information to a server, and that presents notification information to the user.

The term “character information” refers to data representing communication content in a text-based form, including sequences of characters, symbols, and spaces encoded using a character encoding scheme, which are suitable for processing by natural language processing resources.

The term “natural language processing resource” refers to a software or hardware resource configured to analyze character information expressed in a human language, including but not limited to a language analysis program, a linguistic model, or a processing module that performs tokenization, morphological analysis, part-of-speech tagging, entity recognition, or rule-based pattern matching.

The term “tokenization processing” refers to processing that divides character information into smaller units, such as words, morphemes, or symbols, and optionally associates such units with linguistic attributes, for use in subsequent natural language analysis.

The term “information extraction processing” refers to processing that identifies and extracts structured information from character information or tokens, including but not limited to recognizing named entities, detecting patterns that match predefined rules, and deriving feature information indicative of specific semantic categories.

The term “feature information” refers to structured data derived from character information through natural language processing, which represents characteristics of the communication content, including but not limited to expressions related to monetary matters, personal information requests, urgency or threats, or references to network resources, and which is used for evaluating fraud risk.

The term “expression potentially related to fraud” refers to an expression contained in character information that indicates or suggests fraudulent intent or suspicious behavior, such as a request for confidential information, an urgent demand for action, or a reference to a non-trusted network resource, as determined by natural language processing or rule-based evaluation.

The term “prompt sentence” refers to text data generated by the server that encodes instructions and contextual information, including character information and feature information, for input to a generative AI model, in order to request evaluation information such as a fraud risk index and explanatory content.

The term “evaluation instruction content” refers to a portion of a prompt sentence that specifies to a generative AI model what type of analysis or output is requested, including but not limited to instructions to compute a numerical fraud risk index, to provide a classification label, or to generate an explanation regarding fraud risk.

The term “generative AI model” refers to a machine-implemented information processing model configured to generate output data, such as text, based on input data including prompt sentences, and to produce evaluation information such as numerical indices or explanatory descriptions related to the input communication content.

The term “evaluation information relating to fraud risk” refers to information output by a generative AI model or by rule-based processing that quantitatively or qualitatively represents a likelihood, degree, or classification of fraud in communication content, and may include a numerical fraud risk index and explanatory text.

The term “numerical fraud risk index” refers to a numerical value representing a degree of fraud risk associated with communication content, which may be expressed on a predetermined scale, and which is used as a component in calculating a comprehensive fraud risk value.

The term “rule-based pattern matching” refers to processing that compares tokens, entities, or other derived representations of character information against one or more predefined rules or patterns, such as regular expressions, keyword lists, or structural templates, to detect specific types of expressions or behaviors related to fraud.

The term “evaluation value assigned by rule-based pattern matching” refers to a numerical or categorical value associated with communication content based on results of rule-based pattern matching, such as a score increment for detecting a given suspicious pattern, which is used in combination with a numerical fraud risk index from a generative AI model.

The term “comprehensive fraud risk value” refers to an aggregated value that represents an overall fraud risk for communication content, calculated by combining evaluation information from a generative AI model and evaluation values from rule-based processing, for example via weighted synthesis.

The term “danger level classification” refers to a classification category assigned to communication content based on a comprehensive fraud risk value, such as a level indicating safe, suspicious, or likely fraudulent content, and used to control whether and how warning notifications are generated.

The term “notification information” refers to data generated by the server that includes warning content or related metadata corresponding to an evaluated fraud risk, and that is transmitted to a communication terminal for presentation to a user.

The term “warning content” refers to information included in notification information that indicates a risk of fraud or suspicious activity in communication content, and may include guidance or instructions to a user about how to respond, such as not clicking links or not providing personal information.

The term “visual output device” refers to a hardware component configured to provide information in a visual form to a user, such as a display panel or indicator light of a communication terminal.

The term “auditory output device” refers to a hardware component configured to provide information in an audio form to a user, such as a speaker, earphone, or similar audio transducer of a communication terminal.

The term “elderly user” refers to a user who is of an age group for which additional protection or assistance in understanding and responding to suspicious communications is desired, and to whom warning information is presented via a communication terminal.

The term “server” refers to an information processing apparatus including at least one processor and at least one memory, configured to receive communication content from a communication terminal, perform natural language processing and fraud risk evaluation, generate notification information, and transmit the notification information to the communication terminal.

The term “memory storing instructions” refers to a non-transitory computer-readable storage medium in the server that stores program code or data, which, when executed by a processor, causes the processor to perform operations specified in the claims.

The term “processor” refers to a hardware computation unit or units, such as a central processing unit or similar processing circuitry, configured to execute instructions stored in memory to perform the functions described in the claims, including natural language processing, prompt generation, communication handling, fraud risk evaluation, and notification control.

In one embodiment, a server cooperates with a terminal operated by a user to implement a fraud-detection system that analyzes communication content in natural language, evaluates a fraud risk of the communication content, and provides a warning to an elderly user through visual and auditory output devices. The server comprises at least one processor and at least one non-transitory computer-readable memory, and is connected to one or more terminals via a communication network such as the Internet or a mobile communication network.

The server executes an operating system such as a general-purpose server operating system and runs one or more application programs implementing natural language processing, rule-based evaluation, prompt sentence generation, and interaction with a generative AI model. The server uses a natural language processing library, such as a library of the spaCy type or of the NLTK type, for tokenization, morphological analysis, part-of-speech tagging, and entity recognition. The server optionally uses a numerical computation library such as a library of the NumPy type or of the TensorFlow type to perform matrix operations and numerical aggregation when combining model-based scores and rule-based scores. The server may incorporate a graphics processing unit, such as a GPU from a commonly available vendor, to accelerate neural network computations.

The terminal is, for example, a mobile communication device, a tablet device, or a personal computer. The terminal executes an application that acquires incoming emails, text messages, or call transcripts using an application programming interface provided by the operating system of the terminal. The terminal includes a display as a visual output device and a speaker as an auditory output device. The terminal further includes an interface to a text-to-speech engine, such as a text-to-speech service of the mobile operating system, for converting warning messages into audible speech.

The server receives communication content from the terminal as character information. The server stores the character information in a memory structure such as a relational database row or an in-memory record, each record including fields such as a message identifier, a message type identifier, a timestamp, a sender descriptor, and a body text. The server represents the body text as a sequence of characters encoded according to a character encoding scheme such as UTF-8. The server associates with each message an internal data object, for example an object with a field for tokens, a field for entities, a field for extracted feature information, and a field for intermediate and final scores.

The server uses the natural language processing library to convert the character information into a token sequence. The server performs morphological analysis to segment the text into morphemes or words. The server assigns part-of-speech tags to each token, and identifies entities such as organization names, person names, monetary amounts, dates, and network resource references. The server stores these tokens and entities in a structured form, such as an array or list of token objects, each token object including a surface form, a lemma, a part-of-speech tag, and an optional entity tag.

The server performs information extraction processing on the token sequence and entity set. The server maintains a rule set in a configuration storage. The rule set includes, for example, regular expression patterns for detecting email addresses, domain names, shortened URL services, and sequences indicating personal identification numbers, account numbers, or passwords. The rule set further includes phrase patterns for urgency or threat expressions such as “immediately,” “within 24 hours,” “your account will be locked,” and similar language. The server applies these rule patterns to the token sequence and to contiguous n-grams constructed from the sequence. The server then identifies occurrences of expressions matching one or more rule patterns and compiles them into feature information. The feature information includes, as separate attributes, at least one of: a monetary-related expression, a personal information request expression, an expression indicating urgency or threat, and a network resource reference expression.

The server assigns a rule-based evaluation value to the communication content based on the feature information. For example, the server assigns a base score and adds weighted increments such as a first increment for a personal information request, a second increment for an urgent threat to close an account, and a third increment for the presence of a network resource reference that does not match a whitelist of trusted domains. The server stores these increments and a total rule-based evaluation value in the internal data object. The server uses a predetermined mapping between rule patterns and score increments, so that the evaluation is deterministic and reproducible.

The server generates a prompt sentence for a generative AI model based on the character information and the feature information. The server constructs the prompt sentence as a structured text containing explicit instruction content and embedded message content. In one embodiment, the server generates a prompt sentence such as:

“You are a fraud detection assistant. Analyze the following message and determine how likely it is to be a scam.

### Return:

1) A numeric risk score from 0 (definitely safe) to 100 (definitely a scam).
2) A short explanation of the reasons.

### Message:

‘This is an important notice from your bank. Please update your account information immediately by clicking the link below, or your account will be suspended.’”
In another embodiment, the server generates a prompt sentence that explicitly incorporates the feature information extracted by rule-based processing, for example:
“You are a fraud detection assistant. The following message contains the following detected features:
   Personal information request: yes
   Urgency or threat: yes
   Suspicious link: yes

Analyze the message and provide:
1) A risk score from 0 to 100.
2) An explanation referencing the detected features.

### Message:

‘Bank notification: Your account will be locked today unless you verify your identity at the link below.’”

The server uses an interface to a generative AI model hosted locally or provided as a network service. The generative AI model is, for example, a neural network of a transformer architecture type with multiple self-attention layers, feed-forward layers, and layer normalization. The generative AI model is trained in advance using large corpora of text, including benign communications and known fraudulent communications, with supervised fine-tuning that aligns model outputs with desired labels such as fraud risk scores and explanation texts. During training, the generative AI model receives input sequences comprising instruction prefixes and message texts. The model parameters, including weights of attention layers and feed-forward layers, are updated using an optimization algorithm such as stochastic gradient descent or an adaptive variant, with a loss function defined as a combination of a regression loss for risk score prediction and a language modeling loss for explanation text generation. The loss function may include, for example, a mean squared error term for the difference between predicted and reference risk scores, and a cross-entropy term for the token sequence of the explanation, as well as regularization terms.

The server inputs the prompt sentence to the generative AI model. When the generative AI model is deployed as a network service, the server formats the prompt sentence as an input field of a request message, transmits the request via a secure communication protocol, and receives a response containing a generated text. The generated text contains at least a numerical fraud risk index and an explanation. The server parses the generated text according to a defined template, for example by locating a substring of the form “Risk score: X” and extracting X as the numerical fraud risk index.

The server also extracts the remaining explanation part as descriptive evaluation information.

The server calculates a comprehensive fraud risk value by combining the numerical fraud risk index obtained from the generative AI model with the rule-based evaluation value. The server implements a combination algorithm in which a weighted sum or another aggregation function is applied. For example, the server uses a first weight coefficient for the model-based index and a second weight coefficient for the rule-based value, with the sum of the coefficients equal to one. The server obtains a comprehensive value that can be interpreted as an overall fraud probability on a normalized scale.

The server stores the comprehensive risk value in the internal data object associated with the message.

The server determines a danger level classification of the communication content based on the comprehensive fraud risk value. The server maps ranges of the comprehensive fraud risk value to discrete danger levels, such as “safe,” “suspicious,” and “likely scam.” The server may implement this mapping as a configuration table in the memory, so that danger level thresholds are adjustable without modifying the underlying code. The server checks whether the danger level classification satisfies a predetermined condition for issuing a warning, for example whether the level is equal to or more severe than a threshold such as “suspicious.”

The server generates notification information when the danger level classification satisfies the predetermined condition. The notification information includes a warning content element that explains to the elderly user why the message is considered dangerous, and a metadata element that may include the comprehensive fraud risk value and the danger level classification. The server composes natural language warning text by using templates filled with explanation information derived from both the generative AI model's explanation and rule-based pattern matches. For example, the server generates a warning content such as:

“This message is likely to be a scam. The message urgently requests that you update your account information and contains a link that does not match known trusted domains. Do not click the link and do not enter any personal or financial information.”

The server transmits the notification information to the terminal via the communication network.

The terminal receives the notification information and uses the warning content to present a warning to the user. The terminal controls the display to show a prominently colored banner or dialog containing the warning content, and controls the speaker along with the text-to-speech engine to read the warning content aloud. The terminal may also activate vibration or audible alert tones to attract the attention of the user.

The server thereby engages in computer-implemented processing that goes beyond simple automation of human reading or heuristic assessment. The server structurally represents the communication content in a multi-layer data model consisting of character information, tokens, entities, and feature information. The server applies both statistical and rule-based algorithms to these structures. The server produces optimized prompt sentences that encode specific analysis instructions for the generative AI model, thereby improving the efficiency of generative AI processing and reducing redundant computations that would occur if raw text were passed without guidance. By integrating the generative AI model's numerical fraud risk index with the deterministic rule-based evaluation value, the server obtains a comprehensive fraud risk value that benefits from the contextual understanding of the generative AI model and the precision of handcrafted rules.

The server improves computation efficiency and accuracy in several ways. First, the feature extraction step, including rule-based pattern matching, reduces the amount of ambiguity that must be resolved by the generative AI model, enabling the model to focus on critical segments of the communication content. This reduces resource usage, such as the number of tokens that the generative AI model must process, and thus reduces processing time. Second, the combination of a neural risk index with rule-based increments stabilizes the output, reducing variance that might arise from purely generative reasoning, and leads to lower false positives and false negatives compared to conventional systems. Third, the server uses the comprehensive risk value to control whether to send detailed notification information, which allows the system to avoid unnecessary warnings and thereby reduces network load and terminal-side processing.

The server further improves data management by storing intermediate artifacts such as token sequences, feature information, risk indices, and explanations in structured form. This storage enables subsequent analysis, auditing, and retraining of the generative AI model on actual usage data. For example, the server may log cases where the user marks a message as safe despite a high risk score, and may later adjust rule weights or retrain the generative AI model with such counterexamples, thereby continuously improving the technical performance of the fraud detection system.

The server uses processing steps and decision logic that differ from manual human evaluation or simple business-rule workflows. The server defines non-conventional rules that are optimized for machine execution, such as weighting factors for combining neural outputs and rule-based scores, threshold ranges for multi-level classification, and specific feature patterns representing structural aspects of fraud-oriented language in machine-readable form. The server, by design, does not simply replicate human pattern recognition, but encodes a hybrid statistical-symbolic decision process that is implemented in software and executed by dedicated computing hardware.

In another embodiment, the server deploys the generative AI model locally rather than via a remote service. In this embodiment, the server loads a pre-trained transformer-based neural network from storage into memory and executes inference routines using a neural network library such as a library of the PyTorch type. The server divides the prompt sentence into subword tokens using a tokenizer consistent with the training of the neural network. The server feeds the token sequence into multi-head attention layers and feed-forward layers, and obtains logits representing the probability distribution over output tokens. The server decodes a sequence of tokens forming an answer that contains the risk score and explanation. The server applies softmax normalization, beam search, or top-k sampling according to configured parameters, and thereby generates an answer that satisfies a target distribution. Because the model is integrated with the server's data structures and control logic, the server can enforce constraints on the format of the output, for example by training the network to produce answers with explicit numeric prefixes that are easy to parse.

In yet another embodiment, the server may adopt different combination algorithms for the comprehensive fraud risk value, such as a logistic regression function or a small neural network trained on feature information and model-based indices. The server in this case uses a training dataset of labeled messages with known outcomes and trains the combination mechanism using a loss function that measures misclassification error. This learning-based combination further improves accuracy while running efficiently on server hardware because the combination module is significantly smaller than the generative AI model and therefore requires fewer computational resources.

The terminal may be configured differently according to device capabilities. For a smart speaker device, the terminal may principally use auditory output and rely on voice activation commands for user interaction. For a desktop or laptop computer, the terminal may use large-screen visual alerts, highlighting dangerous sections of the communication content. In all cases, the terminal receives notification information from the server and executes device-specific rendering and output control operations, so that the warning is effectively delivered to the elderly user.

Through the cooperation of the server, the terminal, and the generative AI model, the system achieves improved technical performance in fraud detection for natural language communications.

The server reduces computational overhead by structuring data and guiding the generative AI model with optimized prompt sentences. The server increases detection accuracy by merging independent evaluation channels, and the server ensures that warnings are timely and contextually relevant, which is particularly critical for protecting elderly users who may rely heavily on terminal guidance.

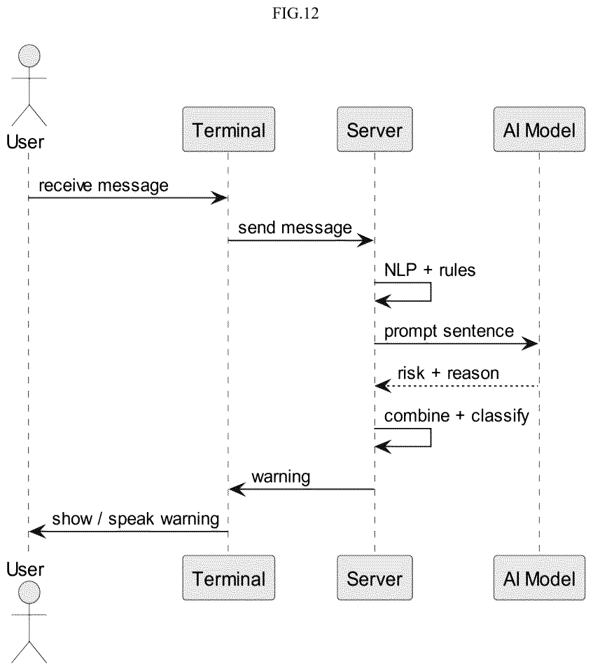

The following describes the processing flow using FIG. 12.

### Step 1:

The terminal acquires communication content.
The terminal receives an incoming communication such as an email, a text message, or a call transcript from an operating system interface. As input, the terminal obtains raw communication data including at least a subject text, a body text, a sender identifier, and a reception timestamp. The terminal converts this raw data into character information by encoding the text in a unified character encoding format and by normalizing line breaks and spaces. As output, the terminal generates a structured communication object that contains fields such as type, subject, body, sender, and timestamp.

### Step 2:

The terminal transmits the structured communication object to the server.
The terminal takes the structured communication object as input and serializes it into a request payload, for example a text-based structured representation, and attaches authentication information such as a token. The terminal sends this payload to a predefined server endpoint over a network protocol. As output, the terminal produces a network request containing the character information and metadata of the communication content.

### Step 3:

The server receives and stores the communication content.
The server takes the network request from the terminal as input and extracts the payload containing the structured communication object. The server validates required fields and decodes the character information. The server then writes the character information and associated metadata into a storage structure, such as a record in a database table or a row in an in-memory store, assigning a unique message identifier. As output, the server produces a stored message record and an internal reference to this record for subsequent processing.

### Step 4:

The server performs text normalization on the character information.
The server reads the stored message record as input and retrieves the body text and, optionally, the subject text. The server applies normalization operations such as converting all characters to a common case where appropriate, removing control characters, and standardizing whitespace. The server may also remove or replace formatting marks that are irrelevant for linguistic analysis. As output, the server generates normalized text that is ready for natural language processing and updates the message record with this normalized text.

### Step 5:

The server executes tokenization and morphological analysis.
The server takes the normalized text as input and invokes a natural language processing library to perform tokenization and morphological analysis. The server splits the text into tokens, and for each token, the server determines a base form (lemma) and a part-of-speech tag using pre-trained language models. This processing is implemented as a sequence of function calls that apply lexical rules and statistical models to the text. As output, the server creates a token sequence, where each token includes attributes such as surface form, lemma, and part-of-speech, and stores this sequence in association with the message identifier.

### Step 6:

The server performs entity recognition and rule-based pattern matching.
The server uses the token sequence and the normalized text as input. The server executes an entity recognition module of the natural language processing resource to identify entities such as organization names, person names, monetary values, and network resource references. The server then applies rule-based pattern matching using predefined patterns, such as regular expressions and phrase templates, to detect monetary-related expressions, personal information requests, urgency or threat expressions, and network resource references. The server matches these patterns against the token sequence and the identified entities. As output, the server produces feature information that lists detected expressions, their positions in the text, and their associated categories, and stores the feature information in the message record.

### Step 7:

The server computes a rule-based evaluation value from the feature information.
The server takes the feature information as input and consults a configuration table that maps each type of detected expression to a numeric score contribution. For each detected feature, the server adds the corresponding score contribution to a running sum. The server thereby performs a numerical aggregation to obtain a rule-based evaluation value representing a preliminary fraud risk estimate. As output, the server stores this rule-based evaluation value in the message record and retains the list of contributing features.

### Step 8:

The server constructs a prompt sentence for the generative AI model.
The server uses the normalized text, the feature information, and the rule-based evaluation value as input. The server composes a prompt sentence by inserting these elements into a predefined instruction template. The server includes explicit instructions to request a numeric risk score and an explanation, and embeds the message text and, optionally, a summary of detected features. The prompt composition involves string concatenation and formatting operations to create a single coherent instruction text. As output, the server generates a prompt sentence that is suitable for input to a generative AI model.

### Step 9:

The server transmits the prompt sentence to the generative ai model and receives evaluation information.
The server takes the prompt sentence as input and issues a model inference request to a generative AI model via a model interface. The server passes the prompt sentence and, optionally, model parameters such as maximum output length or decoding settings. The generative AI model processes the prompt on a neural network architecture and returns a generated text containing a numerical fraud risk index and an explanatory description. The server receives this generated text as output of the model and associates it with the message identifier.

### Step 10:

The server parses the model output to extract the numerical fraud risk index and explanation.
The server takes the generated text from the generative AI model as input and applies parsing rules, such as pattern searching or delimiter-based splitting, to locate a portion corresponding to the numerical risk index and a portion corresponding to the explanation. The server converts the numerical risk index from text format into a numeric value on a predefined scale. As output, the server obtains a model-based fraud risk index as a numeric value and an explanation string, and stores them in the message record.

### Step 11:

The server calculates a comprehensive fraud risk value.
The server takes as input the rule-based evaluation value and the numerical fraud risk index obtained from the generative AI model. The server applies a combination algorithm, for example a weighted sum, where each input value is multiplied by a predetermined weight coefficient and then added to produce a combined value. The server may normalize the combined value to a standard range. As output, the server generates a comprehensive fraud risk value representing an overall risk assessment and records this value in the message record.

### Step 12:

The server determines a danger level classification based on the comprehensive fraud risk value.
The server uses the comprehensive fraud risk value as input and compares it against one or more predefined threshold values stored in a configuration structure. The server evaluates inequality conditions to map the comprehensive fraud risk value to a discrete danger level label, such as “safe,” “suspicious,” or “likely scam.” As output, the server assigns a danger level classification to the communication content and updates the message record with this classification.

### Step 13:

The server generates notification information including warning content.
The server takes as input the danger level classification, the comprehensive fraud risk value, the explanation from the generative AI model, and the feature information. If the danger level classification satisfies a warning condition, the server uses a template-based text generation procedure to construct warning content. The server selects a template according to the danger level and inserts elements derived from the explanation and the detected features, such as mentions of urgent language or suspicious links. As output, the server creates notification information comprising the warning content and relevant metadata, and prepares it for transmission to the terminal.

### Step 14:

The server transmits the notification information to the terminal.
The server uses the notification information as input and encapsulates it into a response message addressed to the terminal that submitted the original communication content. The server sends this response over the communication network using a suitable protocol. As output, the server produces a network response containing the warning content and associated data for the terminal.

### Step 15:

The terminal receives the notification information and presents a warning to the user.
The terminal takes the network response containing the notification information as input and parses the payload to extract the warning content and danger level classification. The terminal then controls its output devices according to predefined rules; for example, the terminal displays a warning banner on the screen and triggers the text-to-speech engine to read the warning aloud if the danger level is high. As output, the terminal presents a visual and/or auditory warning to the user based on the notification information.

### Step 16:

The user reacts to the warning presented by the terminal.
The user observes or listens to the warning content as input and decides how to handle the original communication. Based on the presented information, the user may choose actions such as ignoring the message, deleting it, or reporting it as fraud through a user interface on the terminal. As output, the user's action may be recorded by the terminal and optionally transmitted back to the server as feedback data for future adjustment of evaluation parameters.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional security systems that attempt to protect users from fraudulent links and fraud-related information on networks primarily rely on static blacklist databases, rigid rule sets, or simple pattern matching. These systems are limited in their ability to detect novel or dynamically changing fraud patterns, particularly those that use natural language manipulations, personalized messages, or context-dependent social engineering. As a result, such systems are often unable to accurately evaluate the risk of suspicious communications in real time and to provide timely, intelligible warnings to end users.

This limitation is especially problematic for elderly users, who may have reduced familiarity with digital interfaces, lower tolerance for complex technical messages, and greater susceptibility to deceptive content. Conventional warning mechanisms typically present short, generic notices or highly technical alerts that do not effectively convey the nature of the risk or the appropriate avoidance behavior. Furthermore, existing systems generally treat fraud detection and warning generation as separate processes, without tightly integrating machine-based analysis and the generation of user-tailored explanations.

From a computer-technology standpoint, known architectures for fraud detection do not efficiently exploit generative AI models as configurable components of the processing pipeline. In particular, conventional systems do not define a structured interface in the form of dynamically generated prompt sentences that incorporate multiple heterogeneous signals—such as blacklist comparison results, natural-language-derived risk indicators, and link-structure features—and use those signals to drive both automated risk evaluation and generation of adaptive warning messages. As a consequence, computing resources are not optimally used to synthesize rich contextual analysis into actionable, user-appropriate output.

Additionally, there is no standardized mechanism in conventional systems to jointly (i) monitor user operations on terminals in real time, (ii) offload multi-factor analysis to an external processing apparatus, and (iii) feed back analysis results to a generative model that can express the underlying technical risk in simplified language tailored to the cognitive profile of the elderly user. This lack of integration prevents the computer system from closing the loop between low-level detection events and high-level, behavior-changing feedback, reducing overall protection effectiveness.

Accordingly, there is a need for a computer-implemented technique that improves the technical functioning of a fraud-detection and warning system by: (1) capturing user interaction events and associated content in a structured form; (2) combining database comparison, natural language processing, and structural analysis of links in an automated risk-evaluation pipeline; and (3) using generative AI models through explicitly constructed prompt sentences to automatically generate clear, adapted warning messages. Such a technique should enhance the accuracy and responsiveness of the underlying computer system, while producing warnings that elderly users can easily understand and act upon.

The specific processing by the specific processing unit 290 of the data processing device 12 in Example 2 is realized by the following means.

The present invention provides a server comprising a processor configured to receive, from a terminal operated by an elderly user, identification information of a link or information that the elderly user is about to select, the identification information including at least a network resource locator and text data associated with communication received by the elderly user; a comparison unit implemented by the processor and configured to compare the identification information with stored data of known fraudulent links or fraud-related information in a storage apparatus and to output a comparison result; an analysis unit implemented by the processor and configured to perform natural language processing on the text data to obtain a numerical risk indicator representing a likelihood of fraud and to extract fraud-related terms; a feature extraction unit implemented by the processor and configured to derive feature values based on a structure of the link, including at least a domain component and a path component, and to output the feature values; a risk evaluation unit implemented by the processor and configured to integrate the comparison result, the numerical risk indicator, and the feature values to generate a comprehensive risk evaluation result indicating safety or danger of the link or information; a prompt generation unit implemented by the processor and configured, when the comprehensive risk evaluation result indicates that the link or information is high risk, to generate a prompt sentence that instructs a generative AI model to generate a warning message, the prompt sentence including at least the comprehensive risk evaluation result, content of the link or information, and constraint conditions requiring the warning message to explain reasons why the link or information is dangerous and to specify avoidance actions to be taken by the elderly user, and further specifying a linguistic complexity level according to attribute information of the elderly user; an interface unit implemented by the processor and configured to input the prompt sentence into the generative AI model and to receive, from the generative AI model, the warning message generated in response to the prompt sentence; and a notification unit implemented by the processor and configured to transmit the warning message to the terminal so that the warning message is presented to the elderly user visually or audibly by the terminal. This enables the computer system to technically improve fraud detection and warning functionality by automatically combining database-based comparison, natural-language-based risk assessment, and structural link analysis into a unified risk-evaluation pipeline, and by programmatically controlling a generative AI model through structured prompt sentences so that the server can generate context-aware, user-adapted warning messages that effectively guide elderly users away from dangerous links or information while making more efficient and effective use of computing resources.

The term “system” refers to a combination of one or more hardware apparatuses and software components that cooperate to perform fraud detection, risk evaluation, and warning message generation and presentation.

The term “processor” refers to one or more processing circuits, such as a central processing unit, a graphics processing unit, or a specialized logic circuit, configured to execute instructions that implement the functions described in the claims.

The term “information processing apparatus” refers to an electronic device capable of executing software for communication, browsing, or message handling, including but not limited to a terminal, a client device, or a user-operated computing device.

The term “terminal” refers to an information processing apparatus operated by a user, including but not limited to a mobile device, a personal computer, a tablet, or any client device that displays content and receives user input.

The term “external processing apparatus” refers to a server-side computing environment separate from the terminal, including one or more server devices and associated storage that perform analysis, evaluation, and generative processing based on data received from the terminal.

The term “elderly user” refers to a human user belonging to an age group that typically has reduced familiarity with digital technology and may require simplified explanations or enhanced guidance for safe use of network services.

The term “identification information” refers to data that uniquely or specifically indicates a link or information item, including but not limited to a network resource locator, metadata associated with a communication, and contextual data related to a user operation.

The term “link” refers to a reference to a network-accessible resource, including but not limited to a uniform resource locator, a uniform resource identifier, or other address information that can be used to retrieve content over a communication network.

The term “information” refers to data presented to or received by the user, including but not limited to messages, web pages, documents, or content segments that may contain fraud-related elements.

The term “storage apparatus” refers to any memory or storage system, including volatile memory, non-volatile memory, and external storage services, configured to store data such as known fraudulent links, fraud-related patterns, or configuration information.

The term “known fraudulent links” refers to links that have been previously identified and registered as being associated with fraudulent activities, phishing attempts, or other malicious behavior.

The term “fraud-related information” refers to textual or structural data patterns that are associated with attempts to deceive, defraud, or otherwise exploit a user, including scam messages, phishing content, and misleading prompts for sensitive data.

The term “comparison unit” refers to a functional component implemented by the processor that is configured to compare identification information with stored data and to output comparison results indicating matches, similarities, or classifications.

The term “analysis unit” refers to a functional component implemented by the processor that is configured to perform natural language processing or other analytic operations on text data to derive risk-related metrics or features.

The term “feature extraction unit” refers to a functional component implemented by the processor that is configured to derive structured characteristics, such as domain patterns or path patterns, from a link or associated data for use in risk evaluation.

The term “risk evaluation unit” refers to a functional component implemented by the processor that is configured to integrate multiple signals, including comparison results, numerical risk indicators, and feature values, and to output a comprehensive risk evaluation result.

The term “text data” refers to character-based or symbol-based content, including but not limited to message subjects, message bodies, page text, and metadata strings, which can be processed by natural language processing techniques.

The term “natural language processing” refers to computational techniques for analyzing and interpreting human language text, including tokenization, classification, entity extraction, and semantic analysis, to derive structured information or risk indicators.

The term “numerical risk indicator” refers to a quantitative value, such as a probability, score, or index, that represents a likelihood of fraud or danger associated with a link or information.

The term “feature values” refers to numerical or categorical representations of properties derived from a link or related data, including but not limited to length, domain composition, presence of specific substrings, or structural patterns.

The term “structure of the link” refers to the syntactic components and arrangement of a link, including but not limited to scheme, domain, subdomain, path, query parameters, and any other structural elements.

The term “comprehensive risk evaluation result” refers to an outcome generated by the risk evaluation unit that summarizes, in an integrated form, the safety or danger associated with a link or information, based on multiple underlying indicators.

The term “prompt generation unit” refers to a functional component implemented by the processor that is configured to construct prompt sentences for input to a generative AI model, including specific instructions, constraints, and contextual information.

The term “prompt sentence” refers to a textual instruction set provided to a generative AI model, specifying a task, context, constraints, or desired format, and used to control the behavior and output of the generative AI model.

The term “generative AI model” refers to a machine-learned model configured to generate natural language text or other content in response to input data, including but not limited to large language models trained on text corpora.

The term “warning message” refers to information presented to the user that indicates a risk or danger associated with a link or information, and that may include explanations, recommendations, or instructions for safe behavior.

The term “constraint conditions” refers to specified requirements or limitations embedded in a prompt sentence that guide a generative AI model to produce output having desired properties, such as content coverage, style, length, or complexity.

The term “attribute information of the elderly user” refers to data describing characteristics of the elderly user, including but not limited to age range, language proficiency, cognitive preferences, or accessibility needs.

The term “linguistic complexity level” refers to a degree of difficulty in the language used in a message, including vocabulary, sentence structure, and conceptual density, which can be adjusted according to the comprehension level of the elderly user.

The term “interface unit” refers to a functional component implemented by the processor that is configured to send prompt sentences to the generative AI model and receive generated content from the generative AI model.

The term “notification unit” refers to a functional component implemented by the processor that is configured to transmit warning messages or other output to the terminal for presentation to the user.

The term “presented visually or audibly” refers to the mode in which a message is output to the user, including display on a screen, rendering in a graphical user interface, or playback via audio output such as synthesized speech.

The term “high risk” refers to a state in which the comprehensive risk evaluation result exceeds a predetermined threshold or satisfies a condition indicating that a link or information is likely to be fraudulent or dangerous.

The term “avoidance actions” refers to user behaviors recommended to reduce or eliminate exposure to fraud, including but not limited to not clicking a link, not entering personal information, or closing a suspicious communication.

In one embodiment, a server, a terminal, and a user cooperate to implement the invention.

The server includes at least one processor, a memory, a network interface, and one or more storage devices. The processor may be a general-purpose central processing unit or a graphics processing unit that executes instructions stored in the memory. The storage devices may include persistent storage such as a magnetic disk or a solid-state drive. The network interface connects the server to a communication network.

The terminal includes a processor, a memory, a display, an input device such as a touchscreen, and a network interface. The terminal executes an operating system and one or more application programs, such as a mail client and a web browser. The terminal further executes monitoring software that is configured to observe user operations and to transmit identification information of candidate links or information to the server.

The user operates the terminal to read messages, open web pages, and select links. The user may be an elderly user who prefers simplified explanations and may have difficulty in recognizing sophisticated fraudulent content.

The server executes a program that configures the processor to functionally implement several units: a comparison unit, an analysis unit, a feature extraction unit, a risk evaluation unit, a prompt generation unit, an interface unit, and a notification unit. These units may be implemented as software modules executed by the processor, for example, as separate components in a server-side application framework.

The server uses a storage apparatus to hold a database of known fraudulent links and fraud-related information. The database may be implemented using a relational database management system or a key-value store. The database stores, as records, normalized link structures, associated fraud categories, and risk scores. The storage apparatus may also store configuration data, such as thresholds for risk evaluation and templates for prompt sentences.

The server receives, via the network interface, identification information transmitted from the terminal. The identification information includes at least a network resource locator, and may further include a subject and a body of an electronic communication, metadata about a sender, and contextual information such as a timestamp and a device identifier. The server parses this identification information into an internal data structure, for example, an object that holds fields for URL, subject text, body text, and user attributes.

The server uses the comparison unit to compare a normalized representation of the URL with entries in the storage apparatus. Normalization may include operations such as lowercasing the domain portion, removing tracking parameters from query strings, and decoding percent-encoded characters.

The comparison unit executes search operations, such as exact match search on normalized URLs and prefix or suffix match search on domains and subdomains. The comparison unit outputs a comparison result that may indicate an exact match, a domain-level match, or no match, and may further output a corresponding stored risk score when a match is found.

The server uses the analysis unit to perform natural language processing on the subject and body text. In one embodiment, the analysis unit uses a neural network model based on a transformer architecture. The neural network may consist of multiple self-attention layers, feed-forward layers, and normalization layers. The analysis unit tokenizes the text into tokens according to a subword vocabulary, converts the tokens into numerical embeddings, and passes the embeddings through the transformer layers. The analysis unit then applies a classification head, such as a fully connected layer followed by a softmax function, to produce a probability distribution over classes including at least a fraud-related class and a non-fraud-related class.

The analysis unit outputs a numerical risk indicator, for example a probability score representing a likelihood that the text is associated with fraud. The analysis unit may also extract important terms by examining attention weights or by applying gradient-based saliency techniques to identify tokens that contribute strongly to the fraud-related output. The analysis unit aggregates these important terms as a list of keywords that describe the fraud-related content at a technical level.

The server uses the feature extraction unit to derive feature values based on structural characteristics of the URL. These feature values may include the total length of the URL, the number of subdomains, the presence of digits in the primary domain, the presence of brand-like substrings within non-official domains, and the presence of suspicious words such as “login” or “verify” in the path portion. The feature extraction unit represents these properties as numerical features, for example, as binary indicators, counts, and normalized lengths. The feature extraction unit outputs a feature vector that is suitable for use in calculating a comprehensive risk score.

The server uses the risk evaluation unit to integrate the comparison result, the numerical risk indicator, and the feature vector. The risk evaluation unit may implement a linear or non-linear scoring function. In one embodiment, the risk evaluation unit uses a logistic regression model that takes as input the concatenation of the comparison-result-derived features, the numerical risk indicator from the analysis unit, and the structural feature values from the feature extraction unit.

The risk evaluation unit computes a weighted sum of these features and applies a sigmoid function to obtain a comprehensive risk evaluation result between zero and one. The risk evaluation unit then compares this result to a threshold stored in the storage apparatus to classify the URL as safe or high risk.

The server uses a generative AI model to generate warning messages. The generative AI model is implemented as a large language model based on a transformer neural network architecture trained on large text corpora. The model includes multiple encoder-decoder or decoder-only layers with self-attention and feed-forward networks. During inference, the model receives a text input (prompt sentence) and generates output tokens one by one, conditioned on the prompt and previously generated tokens.

The server uses the prompt generation unit to construct a prompt sentence that controls the behavior of the generative AI model. The prompt generation unit incorporates the comprehensive risk evaluation result, important terms extracted by the analysis unit, structural features indicating suspicious patterns, and attribute information of the elderly user, such as preferred language level. The prompt generation unit inserts constraint conditions in the prompt sentence specifying that the model should produce a short, clear warning in simple language, explain specific reasons for danger, and suggest concrete avoidance actions.

The server uses the interface unit to send the prompt sentence to the generative AI model. The generative AI model may be executed on the same server or on a separate server. The interface unit formats the prompt sentence as text and passes it to the model's inference interface. The model processes the prompt sentence, performs multiple matrix multiplications and non-linear transformations across its layers, and outputs a sequence of tokens that represent the warning message. The interface unit reconstructs the token sequence into human-readable text and passes it to the prompt generation unit or directly to the notification unit.

In a concrete example, the prompt sentence may be:
“You are a security assistant helping an elderly user.

The user is about to click the following link:
URL: https://secure-prize-claim-123.com/login
Email subject: ‘Claim your free prize now!’
Email text snippet: ‘Click here to receive your free gift.’
   Our internal checks show:
The domain is listed as a phishing site.
The message contains typical scam phrases promising free prizes.
The page asks for bank login details.

### Task:

1. Confirm that this link is dangerous for the user.
2. Generate a short, clear warning message in very simple English, telling the user why this is dangerous and what they should do now.
3. Do not include technical jargon.”
   In another example, the prompt sentence may be:

“You are writing a warning for an elderly user.

We have already judged that the link is dangerous.

The email offers a free prize and asks for bank account information.

The website is reported as a phishing site.

Please write a friendly warning message in very simple English.

Tell the user that:
This may be a scam.
They should NOT click the link.
They should NOT enter any passwords or bank details.”

The server uses the notification unit to transmit the generated warning message back to the terminal. The terminal receives the warning message and uses a display component, such as a graphical user interface framework, to present the warning visually as a pop-up or full-screen message. The terminal may also use a text-to-speech engine to convert the warning text into audio and output it through a speaker, enabling auditory presentation.

The user views or hears the warning message on the terminal. The warning message is tailored to the user's comprehension level and includes specific avoidance actions, such as closing the email or not entering personal information. The user can then choose to cancel the pending action, thereby avoiding access to a fraudulent site.

The server implements a specific data flow and internal data structures that contribute to technical improvements. By normalizing URLs and caching intermediate results of comparison and feature extraction, the server reduces redundant computation and accelerates risk evaluation. By representing features as fixed-length numerical vectors and passing them through lightweight models such as logistic regression, the server reduces computation time relative to using heavy models for all tasks. By offloading long-form explanation generation to the generative AI model only when the risk evaluation unit classifies a link as high risk, the server reduces communication load and computing resource usage, since low-risk events result in minimal processing and no complex output.

The server trains the neural network models used in the analysis unit and the generative AI model using machine learning techniques. During training, the server uses a training dataset with labeled examples of fraudulent and non-fraudulent communications. The analysis unit's classification model is trained using a cross-entropy loss function. The server computes the loss between predicted probabilities and true labels and uses gradient descent, such as stochastic gradient descent or an adaptive optimizer, to update the model's weights. The server may apply data augmentation techniques, such as paraphrasing or synonym replacement, to expose the model to varied phrasing of fraudulent messages. This training process yields a model that captures subtle patterns in language beyond human-crafted rules, thereby improving detection accuracy.

For the generative AI model, the server may fine-tune a base language model on a dataset of warning messages and explanations that are specifically designed for elderly users. The server uses a sequence-to-sequence learning objective, where the input is a structured description of risk factors and user attributes and the output is a target warning message. The server computes a loss function over token sequences and updates model parameters accordingly. This fine-tuning causes the model to generate outputs that are concise, polite, and suited to the comprehension level of elderly users.

The server uses non-conventional rules in the risk evaluation and prompt generation process. Instead of directly exposing the raw output of the classification model to the user, the server interprets internal signals and constructs prompt sentences that combine multiple technical aspects (blacklist hits, structural anomalies, textual features) into a structured instruction. This multi-stage architecture produces a two-level decision process: first, a precise, machine-level risk evaluation; second, a controlled, user-oriented explanation. The intermediate prompt sentence serves as an explicit interface between analytical components and generative components, improving explainability and consistency of warnings.

The use of the generative AI model in this architecture improves computer technology itself, rather than merely automating human explanation. The server dynamically modulates the complexity of language and the depth of explanation by embedding constraints and user attributes within the prompt sentence. This allows the model to generate messages that are both informative and short, reducing display clutter and cognitive load for the user, while ensuring that the server does not need to store many fixed templates. As a result, the system reduces memory usage associated with template libraries and improves adaptability to new fraud patterns.

By processing URL structures, textual content, and user behavior jointly, and by feeding these combined signals into a pipeline of specialized units, the server achieves higher detection accuracy and lower false-positive rates compared to conventional static rule-based systems. The integrated design reduces network traffic by sending only compact identification information and concise warning messages between the server and terminal, rather than transmitting entire message bodies or web pages repeatedly. The latency from user action to warning display is reduced by optimized feature extraction and caching, thereby improving responsiveness.

In alternative embodiments, the server may use different types of models for risk evaluation, such as gradient boosting decision trees on the feature vector, while still using a transformer-based generative AI model for warning message generation. The terminal may implement different user interface styles for warning presentation, such as side banners or status bar alerts, while still receiving structured warning messages from the server. The server may also adjust the prompt sentence for different languages, adapting vocabulary and phrasing to local language norms, while preserving the core constraint conditions for clarity and safety.

In another embodiment, the server may operate in a distributed environment, where the comparison unit runs on one physical server and the generative AI model runs on another. The interface unit coordinates data transfer between these machines, but the overall functional structure remains as described. The terminal may be any device capable of executing monitoring software and presenting warnings, including specialized devices for assisted living environments.

Through these configurations, the server, the terminal, and the user interact in a way that improves the functioning of computer-based fraud detection and warning systems. The server combines multiple technical analysis methods, uses neural network models with explicit training and inference processes, and controls a generative AI model through structured prompt sentences to produce machine-generated explanations that are technically grounded yet accessible to elderly users. This architecture yields improved detection accuracy, faster response, and reduced computational and communication overhead, thereby providing a concrete technical improvement over prior systems.

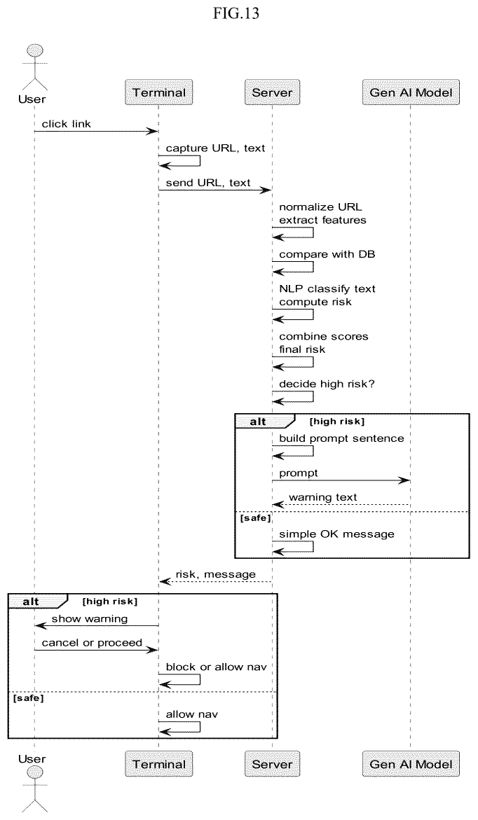

The following describes the processing flow using FIG. 13.

### Step 1:

User operates the terminal to access network content.
User opens a mail application or web browser on the terminal and reads a message or web page. User moves a cursor or taps on a graphical element that represents a link or a button, intending to open a new page or perform an action.
Input: Human interaction events such as touch coordinates, click events, or key presses on the terminal.
Output: A high-level user action event inside the terminal, such as “user intends to open URL X,” which is passed to monitoring components.

### Step 2:

Terminal captures the candidate link and related context.
Terminal executes monitoring software that hooks into browser or mail application events (for example, “before navigation” or “on link click”). Terminal reads the target URL from the application's navigation request, as well as associated context such as the email subject line and a portion of the email body. Terminal obtains device identifiers and a timestamp from the operating system.
Input: Application-level navigation request containing a URL, current message metadata, and device state information.
Output: A structured internal object that includes at least the URL string, subject text, body snippet, user identifier, device identifier, and timestamp.

### Step 3:

Terminal normalizes and packages identification information.
Terminal converts the captured data into a standardized format. Terminal may normalize the URL by trimming whitespace, ensuring encoding consistency, and extracting the scheme, host, path, and query parameters. Terminal then serializes this normalized information into a message format suitable for transmission, such as a JSON-like structure held in memory.
Input: Raw URL and raw text/context captured from the mail application or browser.
Output: A normalized identification information data structure containing fields such as “url,” “subject,” “snippet,” “user_id,” “device_id,” and “timestamp.”

### Step 4:

Terminal sends the identification information to the server.
Terminal opens a secure network connection to the server using a network stack of the operating system. Terminal embeds the identification information in the body of a request and dispatches the request to a predefined server endpoint. Terminal temporarily suspends or delays final navigation to the target URL until a risk evaluation result is received.
Input: Normalized identification information data structure stored in the terminal's memory.
Output: A network request carrying the identification information to the server, and an internal “pending navigation” state within the terminal.

### Step 5:

Server receives and parses the incoming request.
Server, via a network interface and application framework, accepts the request from the terminal. Server reads the request body into memory and uses a parser to decode the serialized structure. Server validates mandatory fields and discards or flags invalid requests.
Input: Network packet stream containing the serialized identification information from the terminal.
Output: An internal server-side object representing the identification information, including the URL, subject text, snippet, user attributes, and device attributes, ready for further processing.

### Step 6:

Server normalizes the URL and extracts structural components.
Server takes the URL string from the identification information and performs normalization operations such as lowercasing the domain, removing known tracking parameters from the query string, and decoding percent-encoded characters. Server then parses the normalized URL into components: scheme, domain, subdomain sequence, path segments, and query key-value pairs.
Input: Raw URL string included in the identification information object.
Output: A structured URL representation containing normalized scheme, host, domain, subdomains, path segments, query parameters, and a canonical URL string.

### Step 7:

Server generates structural feature values of the URL.
Server analyzes the structured URL representation to derive numerical or categorical features. Server calculates the total length of the URL string, the number of subdomains, and the proportion of numeric characters in the primary domain. Server checks for presence of suspicious substrings (for example, “login,” “secure,” “verify,” or “prize”) in the domain and path fields. Server encodes each property as elements of a feature vector, for example binary indicators and integer counts.
Input: Structured URL representation including scheme, host, path, and query parameters.
Output: A URL feature vector representing structural characteristics of the URL.

### Step 8:

Server compares the URL with stored fraud-related data.
Server accesses a storage apparatus that holds entries for known fraudulent links and domains. Server normalizes the stored entries in the same format as the incoming URL. Server performs one or more lookup operations: exact match on the canonical URL string, domain-level match on the host, and pattern match on subdomains or paths. Server obtains a comparison result that may indicate a blacklist hit or a safe status, and may retrieve any associated pre-stored risk score.
Input: Canonical normalized URL from Step 6 and stored fraudulent link records from the database.
Output: A comparison result object indicating match/no-match status, type of match (exact, domain, pattern), and possibly a stored risk score.

### Step 9:

Server prepares text data for natural language analysis.
Server combines the subject text and body snippet received from the terminal into a single text sequence. Server may also add contextual markers, for example tags highlighting the subject or body sections, to preserve structure. Server passes this concatenated text to a natural language processing pipeline for further analysis.
Input: Subject text and body snippet fields from the identification information object.
Output: A unified text document ready for tokenization and embedding.

### Step 10:

Server tokenizes text and computes embeddings.
Server processes the unified text document using a tokenizer associated with a transformer-based classification model. Server converts the text into a sequence of tokens according to a subword vocabulary. Each token is mapped to a numerical embedding vector by a lookup operation. Server constructs a matrix where rows correspond to token embeddings.
Input: Unified text document from Step 9 and a pre-defined tokenizer and embedding table stored in memory.
Output: A token sequence and a corresponding embedding matrix representing the text in a numerical form.

### Step 11:

Server runs a fraud classification model on the text.
Server feeds the embedding matrix into a transformer-based neural network model consisting of multiple layers of self-attention and feed-forward blocks. Server performs matrix multiplications and non-linear operations layer by layer to compute contextualized representations of tokens. Server then applies a classification layer to the representation of a designated token (for example, a special “[CLS]” token) and calculates a probability distribution over classes such as “fraud-related” and “non-fraud-related” using a softmax function.
Input: Embedding matrix and model parameters (weights and biases) of the transformer-based classification model.
Output: A numerical risk indicator (for example, a probability that the text is fraud-related) and internal attention or gradient information that can be used to detect important terms.

### Step 12:

Server extracts important fraud-related terms from the text.
Server uses the attention distribution or gradient-based saliency computed in Step 11 to identify tokens that strongly influence the fraud-related classification output. Server maps the selected tokens back to text spans and aggregates them into a list of significant terms. Server may filter this list to remove stopwords and duplicate terms.
Input: Token sequence, attention weights or gradient scores from the classification model output, and original text.
Output: A set of fraud-related important terms that describe the key elements contributing to the risk judgment.

### Step 13:

Server integrates comparison results, text risk, and URL features.
Server prepares a combined feature vector that includes: (i) numeric indicators representing blacklist match status and stored risk scores from Step 8, (ii) the numerical risk indicator from Step 11, and (iii) the URL feature vector from Step 7. Server concatenates these numeric values into a single array suitable for input into a risk evaluation algorithm.
Input: Comparison result object, numerical risk indicator, and URL feature vector.
Output: A combined risk-evaluation feature vector representing multiple aspects of the detected candidate link.

### Step 14:

Server computes a comprehensive risk evaluation result.
Server uses a risk evaluation model, such as a logistic regression or another light-weight classifier, to process the combined feature vector. Server computes a weighted sum of the feature elements and applies a non-linear function, for example a sigmoid, to obtain a comprehensive risk score between zero and one. Server compares this score against a stored threshold to decide whether the link is high risk or safe.
Input: Combined risk-evaluation feature vector and model parameters (weights and threshold) stored in memory.
Output: A comprehensive risk evaluation result that includes a scalar risk score and a binary classification flag indicating “high risk” or “safe.”

### Step 15:

Server determines whether to invoke the generative AI model.
Server checks the binary classification flag from Step 14. If the result indicates that the link is safe, server may generate a minimal safe-response message without using the generative AI model. If the result indicates that the link is high risk, server proceeds to construct a detailed prompt sentence for the generative AI model.
Input: Comprehensive risk evaluation result containing risk score and classification flag.
Output: A decision to either bypass or invoke the generative AI model, and an internal indicator specifying which path to take.

### Step 16:

Server collects context for prompt sentence construction.
Server gathers necessary information to include in the prompt sentence. Server selects the normalized URL, the unified text document, the numerical risk score, the comparison result (for example, “blacklist hit”), and the extracted important terms. Server also retrieves attribute information about the user, such as a preferred language level (for example, “very simple English for elderly user”).
Input: Normalized URL, unified text document, numerical risk score, comparison result, important terms, and user attribute data.
Output: A structured prompt-context object containing all data elements required for building a detailed prompt sentence.

### Step 17:

Server generates a task-specific prompt sentence for the generative AI model.
Server uses the prompt-context object to build a natural language instruction. Server adds sections that describe: (i) the user scenario, (ii) the suspicious link and text, (iii) internal findings such as blacklist hits and high risk scores, and (iv) explicit tasks for the model, including constraints on language simplicity and required content. Server composes the prompt sentence as contiguous text in a specified language.
Input: Prompt-context object with URL, text, risk results, and user attributes.
Output: A prompt sentence string that encodes instructions, context, and constraints for the generative AI model.

### Step 18:

Server sends the prompt sentence to the generative AI model and requests generation.
Server passes the prompt sentence to the generative AI model through an inference interface. Server tokenizes the prompt sentence via the model's tokenizer and converts tokens to embeddings. The generative AI model processes these embeddings through its transformer layers, incrementally generating output tokens using a probabilistic decoding strategy, such as greedy decoding or beam search.
Input: Prompt sentence text and generative AI model parameters (weights and decoding configuration).
Output: A sequence of output tokens corresponding to a warning message text, assembled into a coherent natural language warning message.

### Step 19:

Server post-processes the generated warning message.
Server converts the output token sequence from the generative AI model into a text string. Server checks whether the length, vocabulary, and style of the text comply with simplicity constraints, for example by counting sentence length and scanning for technical terms. Server may truncate or lightly rephrase parts of the generated text according to predefined rules if it exceeds complexity criteria.
Input: Raw warning message text generated by the generative AI model.
Output: A finalized warning message text tailored to the elderly user, ready to be sent to the terminal.

### Step 20:

Server constructs a response object for the terminal.
Server combines the comprehensive risk evaluation result and the finalized warning message into a structured response. Server includes at least the binary risk classification, the risk score, and the warning message text. Server may add auxiliary data such as a suggested button label or urgency level.
Input: Comprehensive risk evaluation result and finalized warning message text.
Output: A response object containing risk metadata and the warning message content.

### Step 21:

Server transmits the response object to the terminal.
Server serializes the response object and sends it over a secure network connection back to the terminal. Server may log the transaction by writing a record containing the URL, risk score, and timestamp to a log storage for later analysis and model improvement.
Input: Structured response object in server memory.
Output: A network response containing the risk decision and warning message delivered to the terminal, and a persistent log entry stored on the server.

### Step 22:

Terminal receives the response and interprets the result.
Terminal, upon receiving the response, deserializes the data and reads the risk classification flag and the warning message text. Terminal checks the flag; if it indicates “safe,” terminal may proceed with navigation. If it indicates “high risk,” terminal sets an internal state to block the navigation action and prepares to display the warning.
Input: Network response from the server containing the risk classification and warning message.
Output: An internal representation of the server decision and a control decision to either allow or block navigation.

### Step 23:

Terminal presents the warning message to the user.
Terminal uses user interface components to display the warning message on the screen. Terminal may show a dialog window with a title such as “Warning: Dangerous link” and the warning content. Terminal may also invoke a text-to-speech engine to convert the warning text into audio and play it through the speaker. Terminal provides interactive controls such as buttons labeled “Cancel” or “Close,” and may disable or hide options that would continue to the dangerous link.
Input: Warning message text and control decision to block navigation.
Output: A visual and/or auditory warning presentation on the terminal and a set of user interface controls for user response.

### Step 24:

User responds to the warning and finalizes the action.
User reads or listens to the warning and decides whether to proceed or cancel. In a typical case, user taps a “Cancel” or “Close” button, indicating that the user chooses not to access the suspicious link. User's input is captured by the terminal's user interface framework as a new event.
Input: Displayed warning and user interaction with the user interface controls.
Output: A user action event within the terminal that instructs the system to abort or, in exceptional cases, proceed with the requested navigation.

### Step 25:

Terminal executes the final navigation or abort action and optionally reports back.
Terminal, based on the user action event, either cancels the pending navigation operation, closing the email or returning to the previous screen, or proceeds to open the link if the user explicitly overrides the warning. Terminal may create a small feedback record indicating the final user choice and send this record to the server for future analysis, such as tuning thresholds or retraining models.
Input: User action event indicating cancel or proceed, and the previously pending navigation request.
Output: A final navigation state (aborted or executed) on the terminal, and optionally a feedback message to the server containing user action and context.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional fraud-detection systems for electronic communication primarily rely on fixed rules, static reputation lists, or single-purpose machine learning classifiers. These systems typically process message content and link information in isolation, and they generate uniform warning messages that are not adapted to a particular user or context. As a result, such systems often exhibit one or more of the following technical problems.

First, conventional systems cannot effectively combine heterogeneous technical signals, such as natural language content, structured link features, external reputation results, and user interaction history, into a unified, machine-processable fraud-risk representation. The processing pipelines are usually fragmented, meaning that natural language processing, URL analysis, and external reputation queries are executed independently and their results are not coherently integrated. This fragmentation leads to suboptimal fraud-risk estimation, higher false-positive and false-negative rates, and inefficient use of computing resources.

Second, conventional systems do not systematically utilize a generative artificial intelligence model as an internal analytical component that is driven by structured prompt sentences generated from pre-processed technical data. Existing uses of generative models in this domain are often ad hoc, treating the model as a black-box text generator. They do not define a reproducible mechanism in which the system automatically constructs prompt sentences that encode pre-computed risk features, transmits them to the generative model, and then feeds the structured output back into the fraud-detection decision logic. Consequently, the generative model's reasoning capability is not effectively integrated into the core computational workflow.

Third, conventional systems do not adjust their technical behavior based on the emotional state of a user, even though the user's acoustic and visual signals are available as machine-processable data. They may record audio or display warnings, but they do not analyze audio features or image features to infer an emotional state, and they do not modify warning content or user-interface parameters (for example, display mode, voice output mode) based on such state. This limitation results in user interfaces that are not technically optimized for users who may be confused, anxious, or otherwise vulnerable, and it can decrease the effectiveness of warnings in preventing risky actions.

Fourth, existing systems rarely provide a closed technical loop in which all intermediate processing results, prompt sentences, and model outputs are logged and used to adapt both the underlying machine learning models and the prompt-generation strategy. Without this loop, the system cannot efficiently improve its detection performance or its interaction patterns in response to evolving fraud patterns and user behavior.

In summary, there is a need for a computer-implemented technique that (i) unifies content analysis, link analysis, external reputation evaluation, and emotion analysis into a single risk-profiling pipeline, (ii) programmatically generates and uses prompt sentences to coordinate a generative AI model within that pipeline, (iii) dynamically adapts notification control and access control at the terminal based on integrated risk levels and emotional states, and (iv) continuously improves its processing components by logging and learning from detailed runtime data. The technical problem to be solved by the invention is to provide such an integrated, adaptive system that improves the functioning of the computer itself in detecting and handling fraudulent communications, particularly for vulnerable users, while efficiently orchestrating multiple machine learning components and a generative AI model via structured prompts.

The specific processing by the specific processing unit 290 of the data processing device 12 in Application Example 2 is realized by the following means.

The present invention provides a server comprising a processor configured to (i) perform text preprocessing on communication data and link information acquired from a user terminal by using character string processing functionality and natural language processing functionality to extract text information and link information from the communication data and to generate normalized text information and normalized link information; (ii) obtain evaluation information corresponding to the link information by using an external evaluation functionality in order to evaluate safety of the link information and calculate a risk index regarding the link information based on the evaluation information; (iii) calculate a score indicating a probability of fraud by using a machine learning model based on the text information, the link information, the risk index, and source information, and determine a risk level of the communication data based on the score; (iv) generate a first prompt sentence for input to a generative artificial intelligence model by generating summary information that describes in a natural language the text information, the link information, the risk index, and the risk level, input the first prompt sentence to the generative artificial intelligence model, and obtain an evaluation result and explanation information regarding the probability of fraud from the generative artificial intelligence model; (v) identify an emotional state of a user by analyzing emotion-related information including acoustic information and image information using an emotion analysis functionality, and generate a second prompt sentence that instructs the generative artificial intelligence model to create a user-directed warning message based on the emotional state and the evaluation result, input the second prompt sentence to the generative artificial intelligence model, and obtain an adjusted warning message from the generative artificial intelligence model; (vi) generate notification control information for performing at least one of visual notification and auditory notification to the user terminal based on the adjusted warning message and the risk level, and transmit the notification control information to the user terminal; (vii) generate control information for controlling an access request at the user terminal with respect to link information determined to be high risk in the notification control information, and transmit the control information to the user terminal; and (viii) store record information including preprocessing results for the communication data and the link information, the evaluation information obtained by the external evaluation functionality, the score output by the machine learning model, the prompt sentences input to the generative artificial intelligence model, and the evaluation result output from the generative artificial intelligence model, and periodically execute a learning process to update the machine learning model and structures of the prompt sentences based on the record information. This enables the computer system to technically improve fraud-detection accuracy and robustness by unifying heterogeneous analysis modules into a single risk-profiling pipeline, to systematically orchestrate a generative AI model via machine-generated prompt sentences as an internal decision-support component, to dynamically adapt user-interface behavior and access control at the terminal in accordance with integrated risk levels and inferred emotional states, and to continuously refine its models and prompt strategies based on logged operational data, thereby enhancing overall computer functionality in detecting and mitigating fraudulent communications.

The term “communication data” refers to electronic message data including at least one of text content, metadata, and attachment information that is received, transmitted, or displayed by a user terminal.

The term “link information” refers to data representing a network resource identifier, including at least one of a uniform resource locator, a uniform resource identifier, and associated parameters such as domain, path, query, and protocol.

The term “user terminal” refers to an electronic apparatus operated by a user, including at least one of a portable terminal device, a stationary terminal device, and a display device, that is capable of sending data to and receiving data from a server over a communication network.

The term “processor” refers to a hardware processing unit, such as a central processing unit, a graphics processing unit, or a programmable logic device, that executes computer programs to perform arithmetic, logic, and control operations.

The term “character string processing functionality” refers to a software or hardware function that performs operations on character data, including at least one of parsing, pattern matching, normalization, and format conversion of text.

The term “natural language processing functionality” refers to a software or hardware function that analyzes and processes human language text, including at least one of tokenization, part-of-speech tagging, entity extraction, syntactic analysis, and semantic analysis.

The term “normalized text information” refers to text information that has been transformed into a standardized representation by operations such as character encoding unification, removal of unnecessary symbols, and linguistic normalization including stemming or lemmatization.

The term “normalized link information” refers to link information that has been converted into a standardized representation by operations such as lowercasing, removal of redundant parameters, canonicalization of paths, and decomposition into structural elements.

The term “external evaluation functionality” refers to a software or hardware function that obtains evaluation information related to link information from an external source, such as a reputation service or threat-intelligence service, by using a communication interface.

The term “evaluation information” refers to data received from the external evaluation functionality that indicates a safety condition, risk category, or reputation status associated with link information.

The term “risk index” refers to a numerical or categorical indicator computed from evaluation information and other technical features that quantitatively or qualitatively represents a degree of risk associated with link information.

The term “machine learning model” refers to a computational model generated by a training process using sample data, which receives feature data as input and outputs a prediction value, such as a probability, score, or classification result.

The term “source information” refers to data related to an origin of communication data, including at least one of sender identifiers, addresses, account identifiers, and historical behavior records.

The term “score indicating a probability of fraud” refers to a numerical value output by the machine learning model that represents a likelihood that communication data or link information is associated with fraudulent activity.

The term “risk level” refers to a classification value that indicates a degree of risk of fraud for communication data, determined based on at least one score indicating a probability of fraud and optionally other derived indicators.

The term “generative artificial intelligence model” refers to a trained computational model that receives an input sequence, such as a prompt sentence, and outputs generated content, such as explanatory text, warning messages, or structured responses, according to learned patterns.

The term “prompt sentence” refers to a text sequence encoded in natural language or a structured format that specifies an instruction, query, or context to be supplied as input to a generative artificial intelligence model.

The term “summary information” refers to data derived from detailed technical information, such as text information, link information, risk indexes, and risk levels, and expressed in a compressed natural language form suitable for inclusion in a prompt sentence.

The term “evaluation result” refers to information output by the generative artificial intelligence model in response to a prompt sentence, which indicates at least one of a qualitative assessment, a quantitative score, and a classification regarding a probability of fraud.

The term “explanation information” refers to text output by the generative artificial intelligence model that describes reasons, evidence, or rationale supporting an evaluation result regarding a probability of fraud.

The term “emotion-related information” refers to digital data associated with a user's behavior or state, including at least one of acoustic information, image information, and interaction patterns, which is used to infer an emotional state.

The term “acoustic information” refers to audio data representing a user's voice or surrounding sound, including features such as pitch, volume, and temporal patterns, that can be processed for emotion analysis.

The term “image information” refers to visual data such as still images or video frames that include at least a part of a user's face or body, which can be processed to extract facial expressions or other visual cues.

The term “emotion analysis functionality” refers to a software or hardware function that processes emotion-related information to estimate an emotional state, using one or more of signal processing, pattern recognition, and machine learning.

The term “emotional state” refers to a classification or representation of a user's emotional condition, such as calm, confused, anxious, or angry, inferred from emotion-related information by the emotion analysis functionality.

The term “user-directed warning message” refers to content intended to alert a user to a risk associated with communication data or link information, the content being generated or adjusted according to the user's emotional state or context.

The term “adjusted warning message” refers to a user-directed warning message produced by taking into account at least the emotional state and an evaluation result, such that the wording, tone, or length is adapted to the user.

The term “notification control information” refers to control data transmitted from the server to the user terminal that specifies at least one of a type, timing, layout, and modality of notification to be provided to the user.

The term “visual notification” refers to a notification presented on a display of the user terminal, including at least one of a dialog, pop-up, banner, icon, or color change, which conveys a warning or guidance to the user.

The term “auditory notification” refers to a notification presented as sound output by the user terminal, including at least one of synthesized speech, recorded voice, and alert tone, which conveys a warning or guidance to the user.

The term “control information” refers to data transmitted from the server to the user terminal that instructs the user terminal to allow, block, or otherwise regulate execution of an access request associated with link information.

The term “access request” refers to a request initiated at the user terminal to perform a network access or related action, including at least one of opening a link, connecting to a remote resource, or initiating a communication session.

The term “high risk” refers to a risk level indicating that communication data or link information exceeds a predetermined threshold for probability of fraud or danger, such that protective measures are to be applied.

The term “question sentence” refers to a text input provided by the user that requests an assessment, explanation, or recommendation from the generative artificial intelligence model regarding communication data or link information.

The term “advice information” refers to guidance output by the generative artificial intelligence model in response to a prompt sentence that includes a question sentence, the guidance indicating recommended user actions or precautions.

The term “record information” refers to stored data that includes at least preprocessing results, evaluation information from external evaluation functionality, scores from the machine learning model, prompt sentences supplied to the generative artificial intelligence model, and evaluation results output by the generative artificial intelligence model.

The term “learning process” refers to a procedure in which the machine learning model and at least one structural aspect of prompt sentences are updated by using record information, in order to improve prediction performance or interaction quality over time.

The term “user interface information” refers to data that defines parameters of a user interface at the user terminal, including at least one of display mode, layout, color scheme, font size, and voice output mode, which are used to present notifications or messages.

The term “display mode” refers to a configuration of visual output at the user terminal, such as full-screen alert, dialog box, overlay, or inline message, selected based on risk level or emotional state.

The term “voice output mode” refers to a configuration of auditory output at the user terminal, including at least one of language, voice type, volume, and speech rate, selected based on risk level or emotional state.

In one embodiment, a server cooperates with one or more terminals operated by a user to implement the claimed system. The server includes at least one processor, a main memory, a non-volatile storage device, and a network interface that connects to the terminals via a communication network. The processor executes programs stored in the non-volatile storage device to perform the functions described below. The terminals each include a processor, a memory, a display, an audio output device, a microphone, a camera, and a communication interface.

The server uses a general-purpose processor such as a central processing unit and optionally one or more accelerators such as graphics processing units to execute computation-intensive operations. In one concrete configuration, the server executes an operating system of a server-class type and runs an application layer implemented in a programming language such as a scripting language or a compiled language. The server loads software libraries that provide string processing, natural language processing, signal processing, and machine learning functionality. Examples of such libraries include a natural language processing library capable of tokenization and entity extraction, a numerical computing library for tensor operations, and a computer-vision library for image processing. The server also stores trained parameters for a machine learning model for fraud scoring and for an emotion analysis model.

The server receives communication data and link information from the terminals and from associated communication services. The server obtains message bodies, headers, sender information, and link information via application programming interfaces provided by message servers or via HTTP requests from the terminals. The server stores this information in structured form in a storage system. In one embodiment, the server stores each communication as a record containing fields for message identifier, sender identifier, time stamp, raw text, normalized text, and risk level, and stores each link as a record containing fields for link identifier, uniform resource locator string, domain, path, query parameters, external reputation score, and associated communication identifier. This explicit data structure enables efficient indexing and retrieval when the machine learning models are executed.

The server performs text preprocessing by applying character string processing functionality and natural language processing functionality. The server removes markup tags such as hypertext tags, decodes character encodings into a unified encoding, splits text into sentences and tokens, removes stop words, and performs lemmatization. The server further applies a named-entity recognizer to detect entities such as financial institutions, personal names, addresses, and numerical amounts. By converting diverse raw messages into normalized text information and structured entities, the server reduces dimensionality and noise in later machine learning steps, which improves model accuracy and reduces computation time.

The server processes link information by parsing each uniform resource locator string into scheme, host, domain, subdomain, path, and query parameters. The server normalizes the link by lowercasing the domain, sorting or removing tracking parameters, and canonicalizing the path. The server computes engineered features such as domain length, number of subdomains, presence of numeric characters, and similarity to known domains. The server stores these features as a fixed-length feature vector in the link record. These engineered features capture structural characteristics of malicious links that cannot be reliably extracted by conventional rule-based filters and thus enable improved discrimination by the machine learning model.

The server communicates with an external evaluation functionality that provides reputation and threat information regarding link information. The server transmits normalized link information to the external evaluation functionality via a secure protocol and receives evaluation information indicating categories such as phishing, malware, or safe. The server converts such evaluation information into numerical scores and stores the scores in the link record. Because the server caches these results and associates them with specific link identifiers, subsequent access to the same link can be evaluated with reduced network traffic and lower latency, thereby reducing communication load and improving response time at the terminals.

The server constructs a combined feature vector for each communication by aggregating text-based features, link-based features, external reputation scores, and source information such as historical sender risk. In one embodiment, the server represents the normalized text information using word or sentence embeddings generated by a neural network such as a transformer encoder, represents the link features as a normalized numeric vector, and concatenates these with one-hot or embedding representations of source information. The server feeds the combined feature vector to a machine learning model that outputs a score indicating a probability of fraud.

In one embodiment, the machine learning model is a deep neural network comprising an input layer corresponding to the combined feature vector, one or more hidden layers, and an output layer that produces at least one scalar value representing a probability of fraud. The hidden layers may include fully connected layers with rectified linear unit activation functions, dropout layers for regularization, and normalization layers. During training, the server minimizes a loss function such as cross-entropy between the predicted probability and a ground-truth label using an optimization algorithm such as stochastic gradient descent with adaptive learning rate. The server updates the model parameters by back-propagation and stores the trained parameters in the storage device. By learning non-linear relationships among heterogeneous features, this model reduces false positives and false negatives compared to simple rule-based systems and thus technically improves fraud-detection performance.

The server further performs emotion analysis by processing emotion-related information from the terminals. The terminals capture acoustic information via the microphone and image information via the camera under user consent. The terminals encode the audio in a digital audio format and the image data in a compressed visual format and transmit them to the server. The server extracts acoustic features such as Mel-frequency cepstral coefficients, pitch, energy, and speaking rate, and feeds them to a neural network model trained for emotion classification. The server also uses a computer-vision model to detect facial landmarks and classify facial expressions. In one embodiment, the emotion analysis model includes a convolutional neural network for image features and a recurrent neural network or transformer-based network for temporal audio features, followed by fusion layers that output an emotional state label such as calm, confused, anxious, or angry. The training of this model uses labeled emotion data and an appropriate loss function, and the server updates model parameters by gradient-based optimization. This multi-modal emotion inference provides the server with a technical signal that conventional fraud filters do not use and enables more effective control of user interface behavior.

The server integrates the fraud probability score and the emotional state to derive a risk level and a user interface profile. The server maps the fraud probability score to discrete levels such as low, medium, high, and critical. The server further combines this level with the emotional state to compute parameters such as whether to display warnings in full-screen mode, whether to use high-contrast colors, and whether to slow down speech and repeat key phrases. This mapping can be implemented as a rule table or as a small decision model. Because this mapping is performed on the server and encoded in structured notification control information, the terminals can render adaptive warnings without implementing complex decision logic locally, which simplifies terminal software and ensures consistent behavior across devices.

The server uses a generative AI model to produce higher-level analysis and user-directed content. The server generates a first prompt sentence by converting the summary information, including normalized text information, normalized link information, risk indexes, and risk levels, into natural language. For example, the server may generate a prompt sentence such as: “Act as a fraud-detection assistant for an elderly user. Analyze the following data. Email text: ‘ . . . ’ URL:‘https://bank-secure-update.com’ ML_fraud_score:0.87 URL_reputation: high-risk, SOCIAL_ENGINEERING User_emotion: confused. Decide if this is likely a fraud, give a risk score 0-1, and explain in two short sentences in simple English.”

The server inputs this prompt sentence to a generative AI model such as a large-scale neural language model that has been trained on a corpus of text data. The generative AI model applies an internal architecture such as a multi-layer transformer with self-attention heads, feed-forward layers, and learned positional encodings. The model generates an output sequence that includes an evaluation result (for example, “risk 0.93”) and explanation information. The server then parses this output and stores the evaluation result and explanation.

The server generates a second prompt sentence to request a user-directed warning message adapted to the emotional state and the evaluation result. For example, the server may generate a prompt sentence such as:
“You are a safety assistant helping an elderly user. The message above is likely a fraud (risk 0.94). The user is anxious. Generate one short, kind, and very clear warning message that avoids technical terms and directly tells the user what to do. Output only the warning sentence.”

The server inputs this prompt sentence to the generative AI model and obtains an adjusted warning message such as:

“This link is very dangerous. Please do not click it and do not tell anyone your bank numbers.”

The server embeds this adjusted warning message and associated risk level into notification control information transmitted to the terminals. By generating structured prompt sentences that incorporate pre-computed technical features, the server uses the generative AI model as a deterministic component of a larger pipeline rather than as a generic text generator, and therefore the behavior is reproducible and technically constrained.

The server also supports direct queries from the user by generating a third prompt sentence when the user submits a question. The terminals display an input field or capture speech to allow the user to ask questions such as “Is this link safe?” or “Is this phone call a scam?”. The terminals transmit the question along with context such as the current message text and link information. The server embeds these in a prompt sentence such as:
“An elderly user asks: ‘Is this link safe?’ Context: SMS text: ‘Your package is waiting. Confirm here: https://parcel-check-id123.com’. Use clear reasoning and answer in simple English if the user should click or not.”
The server inputs this third prompt sentence to the generative AI model and receives advice information containing recommended actions such as “Do not click the link” and “Contact the official organization directly.” The server distributes this advice information to the terminals.
The terminals interpret the notification control information and control information provided by the server. Each terminal renders visual notification on its display according to parameters such as display mode, color scheme, font size, and positioning. In a high-risk and anxious-user situation, the terminal may display a full-screen warning with large fonts and a simple message. The terminals also generate auditory notification by using a text-to-speech engine to read the adjusted warning message aloud. The terminals configure parameters such as speech rate, volume, and voice type according to the voice output mode indicated by the server. The terminals intercept access requests at the operating system or application level, such as requests to open a link in a browser, and apply control information by blocking or delaying the request unless the user explicitly overrides the warning. This direct control over device behavior demonstrates that the system goes beyond abstract evaluation and physically alters how the terminal accesses external network resources.

The server logs record information for each processed communication, including preprocessing results, evaluation information from the external evaluation functionality, machine learning model scores, prompt sentences, and outputs from the generative AI model. The server stores these logs in a structured data store with indexes on risk levels, types of fraud, and model outputs. Periodically, the server executes a learning process in which it samples record information, re-computes target labels based on confirmed fraud cases or user feedback, and re-trains the machine learning models and adjusts the structure of prompt sentences. For example, the server may modify which features are included in the summary, or change phrasing patterns in prompt sentences to elicit more precise responses from the generative AI model. This closed-loop adaptation allows the system to track evolving fraud patterns and user behavior while improving computational efficiency and detection precision.

The described configuration improves computer technology in several ways. The integration of normalized multi-modal features into a single numerical vector allows the machine learning model to perform a single forward pass that replaces multiple separate rule-based checks, thereby reducing processing time and memory accesses. The explicit caching of external evaluation information reduces redundant network calls and thus lowers communication load and latency. The combination of structured prompt sentences and generative AI model output enables the server to generate human-readable explanations and warnings without storing pre-written templates for every fraud scenario, which decreases storage requirements and simplifies software maintenance. Because the emotion analysis model adapts the user interface mode to the user's emotional state, the system reduces user errors such as accidental clicks on dangerous links, which in turn lowers the number of repeated interactions and re-processing of similar communications.

In contrast to human operators manually examining messages, the server employs non-intuitive feature engineering and neural network architectures that can process large volumes of communications in real time. The feature extraction, model execution, and prompt generation follow deterministic, algorithmic steps that are not mere automation of human reading. For instance, the fraud-scoring model might weigh domain length and token rarity in a manner that is not part of ordinary human reasoning. The emotion analysis model aggregates subtle acoustic and facial cues at millisecond resolution, which are not accessible through human observation at scale. The generative AI model is controlled via machine-generated prompt sentences that encode numerical risk data and structural context, an interaction pattern that is unique to computer-based language models and does not have a direct human analog.

In another embodiment, the server employs alternative machine learning architectures. For example, the fraud-scoring model may be implemented as a gradient-boosted decision tree ensemble that operates on engineered features without using embeddings. The emotion analysis may use only acoustic features without image information, or vice versa, depending on device capabilities and privacy settings. The generative AI model may be hosted locally on the server or accessed as a remote service, as long as the server generates prompt sentences and consumes the responses. Different loss functions, such as focal loss for imbalanced data or mean squared error for regression outputs, may be used in training. Data augmentation methods such as synonym replacement in text or time-stretching in audio may be applied to enhance model robustness.

In still another embodiment, the terminals perform a portion of the preprocessing or emotion analysis. A terminal may locally compute simple acoustic features or preliminary emotion estimates and transmit only compact representations to the server, thereby reducing bandwidth usage. A terminal may also cache recent notification control information and apply it to similar future messages temporarily when connection to the server is unavailable. In all such variations, the essential operations remain that the server receives normalized technical data, computes fraud probabilities using a machine learning model, generates structured prompt sentences for a generative AI model, obtains evaluation results and adjusted warning messages, and transmits notification and access control information to the terminals.

Through these embodiments, the server, the terminals, and the user cooperate in a technical interaction. The server applies advanced machine learning and generative AI techniques with clearly defined data structures and algorithms; the terminals control actual device resources such as displays, audio output, network interfaces, and input mechanisms; and the user receives adaptive, technically optimized warnings and advice. This configuration provides specific, practical applications of generative AI models and machine learning models that enhance the functionality of the underlying computer system for fraud detection and mitigation.

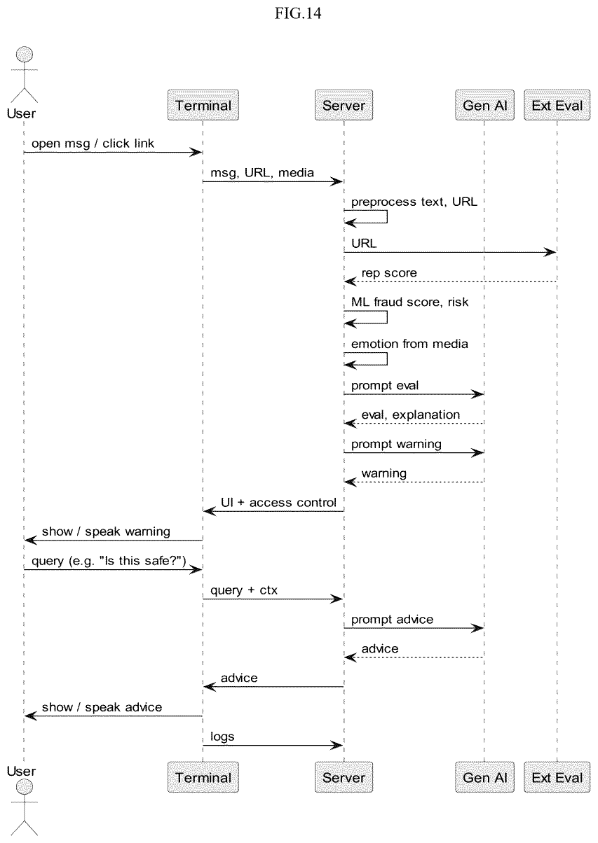

The following describes the processing flow using FIG. 14.

### Step 1:

Server acquires raw communication data and link information.
Server receives, as input, message data from external message services and from the terminal, including message bodies, headers, sender identifiers, timestamps, and raw link strings. Server uses network interfaces and communication protocols to call application programming interfaces and to accept HTTP requests from the terminal. Server parses the received payloads and stores each message and each link as structured records in a storage device. Server outputs normalized internal records that include fields such as message ID, sender ID, raw text, and raw link information.

### Step 2:

Server performs text preprocessing on the communication data.
Server takes, as input, raw text fields from the stored message records. Server applies character string processing and natural language processing to remove markup tags, decode character encodings, split the text into tokens, remove stop words, and perform lemmatization. Server further executes a named-entity recognizer to extract entities such as organization names, monetary amounts, and personal identifiers. Server combines the processed tokens and entities into normalized text information and updates the corresponding message records. Server outputs, for each message, a normalized text field and an entity list that will be used as input to later models.

### Step 3:

Server parses and normalizes link information.
Server receives, as input, raw link strings from the link records generated in Step 1. Server uses a parsing routine to decompose each link into scheme, host, domain, subdomain, path, and query parameters. Server then performs normalization, including lowercasing the domain, removing redundant or tracking parameters, and canonicalizing the path format. Server computes structural features such as domain length, number of subdomains, presence of numeric characters, and character distribution statistics. Server stores the normalized link information and a feature vector in the link record. Server outputs normalized link fields and link feature vectors that are suitable for machine learning.

### Step 4:

Server obtains external evaluation information for links.
Server takes, as input, normalized link information and associated identifiers from Step 3. Server calls an external evaluation functionality through a communication interface, transmitting each normalized link string. Server receives, as output, evaluation information such as risk categories, reputation scores, or detection counts. Server converts this evaluation information into a numerical or categorical risk index, associates it with the link record, and stores it in the storage device. Server outputs, for each link, an updated record that includes the external risk index.

### Step 5:

Server constructs combined feature vectors for fraud scoring.
Server receives, as input, normalized text information from Step 2, link feature vectors and risk indexes from Steps 3 and 4, and source information such as sender history from the storage device. Server converts the normalized text information into numeric representations, for example by computing embeddings using an internal encoder. Server concatenates text embeddings, link feature vectors, external risk indexes, and encoded source information into a single combined feature vector. Server writes these combined feature vectors into a temporary buffer or feature table. Server outputs one combined feature vector per message or per communication session.

### Step 6:

Server calculates a fraud probability score and a risk level.
Server takes, as input, the combined feature vectors from Step 5. Server feeds each feature vector into a machine learning model that has been previously trained, causing the model to perform a forward pass and output a score indicating a probability of fraud. Server then applies threshold logic to map the score into a discrete risk level such as low, medium, high, or critical. Server updates the message record with the fraud probability score and the assigned risk level. Server outputs, for each communication, a fraud probability score and a risk level value.

### Step 7:

Server analyzes emotion-related information from the user.
Server receives, as input, emotion-related information from the terminal, including acoustic information captured by the microphone and image information captured by the camera, together with identifiers linking this information to a specific communication. Server performs signal processing on the acoustic information to extract features such as frequency coefficients, pitch, energy, and speaking rate. Server performs image processing on the image information to detect facial landmarks and to derive expression features. Server inputs the acoustic features and image features to an emotion analysis model, which outputs an emotional state classification. Server stores the emotional state in an emotion field associated with the user and the current communication. Server outputs an emotional state label such as calm, confused, anxious, or angry.

### Step 8:

Server generates summary information for generative AI analysis.
Server takes, as input, normalized text information, normalized link information, fraud probability score, risk level, external risk index, and emotional state from Steps 2, 3, 4, 6, and 7. Server assembles these elements into a structured summary that describes the situation in a compact form. Server converts this structured summary into natural language by inserting the values into predefined textual patterns. Server thus produces a summary text that is readable and suitable for inclusion in a prompt sentence. Server outputs a summary text string that encapsulates technical data about the communication.

### Step 9:

Server generates a first prompt sentence and invokes the generative AI model for evaluation.
Server receives, as input, the summary text from Step 8. Server constructs a first prompt sentence by combining an instruction part and the summary text. For example, server generates a prompt sentence such as:
“Act as a fraud-detection assistant for an elderly user. Analyze the following data. Email text: ‘ . . . ’ URL: ‘https://bank-secure-update.com’ ML_fraud_score: 0.87 URL_reputation: high-risk, SOCIAL_ENGINEERING User_emotion: confused. Decide if this is likely a fraud, give a risk score 0-1, and explain in two short sentences in simple English.”
Server sends this prompt sentence as input to a generative AI model via a model interface. Server receives, as output, a generated text containing an evaluation result, for example a risk score and a brief explanation. Server parses the generated text to extract the numerical risk indication and the explanation information, and stores both in the message record. Server outputs an enhanced evaluation result and explanation derived from the generative AI model.

### Step 10:

Server generates a second prompt sentence for a user-directed warning message.
Server takes, as input, the emotional state from Step 7 and the enhanced evaluation result from Step 9, including the risk level and explanation. Server constructs a second prompt sentence that instructs the generative AI model to produce a clear warning adapted to the user. For example, server generates a prompt sentence such as:
“You are a safety assistant helping an elderly user. The message above is likely a fraud (risk 0.94). The user is anxious. Generate one short, kind, and very clear warning message that avoids technical terms and directly tells the user what to do. Output only the warning sentence.”
Server transmits this second prompt sentence to the generative AI model and receives a generated warning message as output. Server stores the warning message as a text field associated with the communication. Server outputs an adjusted warning message that is tailored to the risk and the emotional state.

### Step 11:

Server creates notification control information and access control information.
Server receives, as input, the risk level from Step 6, the emotional state from Step 7, and the adjusted warning message from Step 10. Server determines user interface parameters such as display mode, color scheme, font size, and voice output mode by applying decision rules or a small decision model to the risk level and the emotional state. Server encapsulates these parameters and the warning message into notification control information. Server also determines, based on the risk level and risk indexes, whether link access should be allowed, blocked, or require explicit user confirmation, and encodes this policy into access control information. Server packages the notification control information and access control information into a message addressed to the terminal. Server outputs a control payload that instructs the terminal how to notify the user and how to handle access requests.

### Step 12:

Terminal presents notifications and enforces access control.
Terminal receives, as input, the notification control information and access control information from the server. Terminal reads the display mode, color scheme, font size, and warning message from the notification control information, and renders visual notification on the display accordingly, for example by showing a full-screen red warning with large text for a critical risk level. Terminal reads the voice output mode and uses a text-to-speech engine to synthesize an audio version of the warning message at a speed and volume suited to the user. Terminal intercepts access requests related to the link information, such as attempts to open the link in a browser, and compares the request to the access control information. Terminal either blocks the request, requires an explicit override from the user, or allows the request, depending on the policy. Terminal outputs visible and audible feedback to the user, and produces an action result indicating whether the access was blocked or allowed.

### Step 13:

User responds to the warnings and may issue a direct query.
User receives, as input, the visual notification and auditory notification presented by the terminal.
User reads or listens to the warning and then either cancels the action, accepts the recommendation, or insists on proceeding. User may also enter a direct question via a text input field or speech input, such as “Is this link safe?” or “Is this phone call a scam?”. Terminal captures this question and the current context and sends them to the server. User's choice and question are output from the terminal as user interaction data.

### Step 14:

Server generates a third prompt sentence for user queries and returns advice.
Server takes, as input, the user question and associated context information, including the current message text and link information. Server constructs a third prompt sentence that embeds the question and context in an instruction to the generative AI model. For example, server generates a prompt sentence such as:
“An elderly user asks: ‘Is this link safe?’ Context: SMS text: ‘Your package is waiting. Confirm here: https://parcel-check-id123.com’. Use clear reasoning and answer in simple English if the user should click or not.”
Server sends this third prompt sentence to the generative AI model and receives, as output, advice information in the form of generated text describing whether the link should be clicked and what alternative actions the user should take. Server stores the advice information and transmits it to the terminal as part of a response message. Server outputs a user-oriented explanation and recommendation.

### Step 15:

Terminal displays advice and logs interaction results.
Terminal receives, as input, the advice information from the server. Terminal displays the advice text on the screen in a readable layout and optionally uses text-to-speech to read the advice aloud.
Terminal also records the user's subsequent action, such as closing the message, deleting the communication, or ignoring the advice, along with timestamps and identifiers. Terminal sends a summary of these interaction results back to the server. Terminal outputs both the user-visible advice and a log of user behavior for learning purposes.

### Step 16:

Server updates record information and supports model learning.
Server takes, as input, the logs from the terminal and all intermediate data generated in previous steps, including preprocessing results, external evaluation information, fraud scores, risk levels, emotional states, prompt sentences, generative AI outputs, and user behavior. Server inserts or updates this record information in a persistent data store. At scheduled times, server selects subsets of this record information and uses them to retrain or fine-tune the machine learning model and to adjust the structure and content of prompt sentences. Server recalculates model parameters by minimizing a predefined loss function over the stored examples and updates decision thresholds if necessary. Server then deploys the updated models and prompt templates for use in future processing. Server outputs improved model parameters and prompt configurations that enhance fraud-detection accuracy and user interaction quality over time.

The data generation model 58 is a so-called generative artificial intelligence (AI). Examples of the data generation model 58 include generative AIs such as ChatGPT (registered trademark) (Internet search <URL:https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

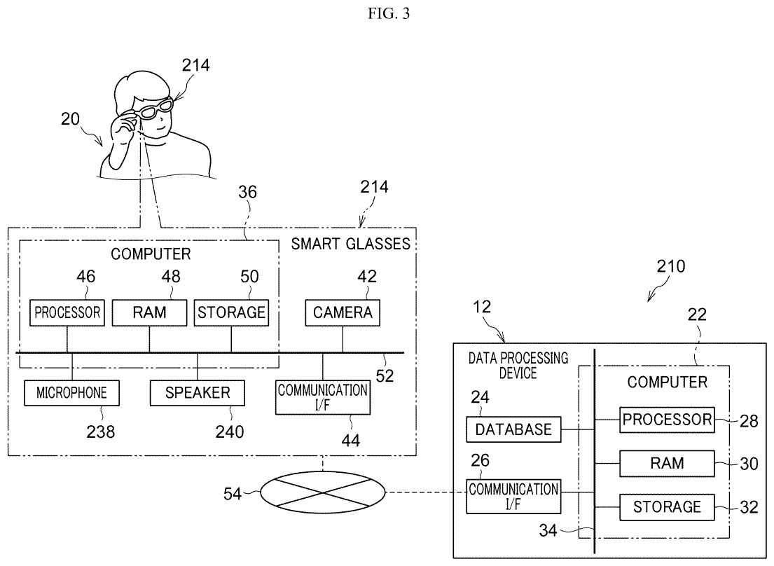

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

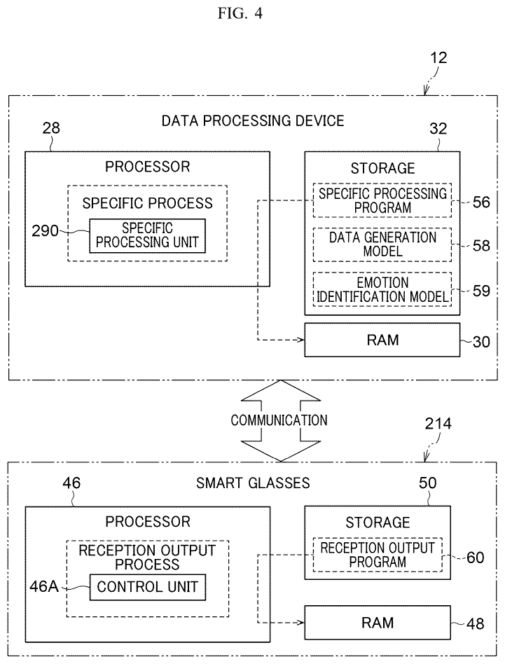

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

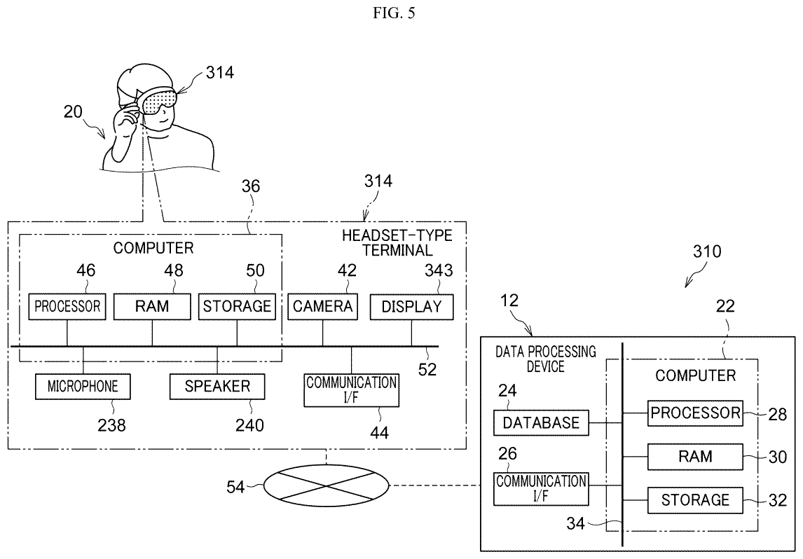

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

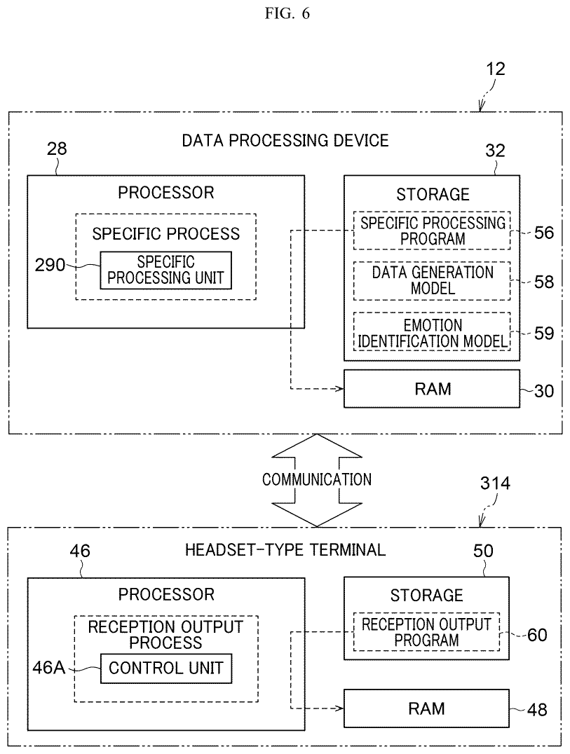

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

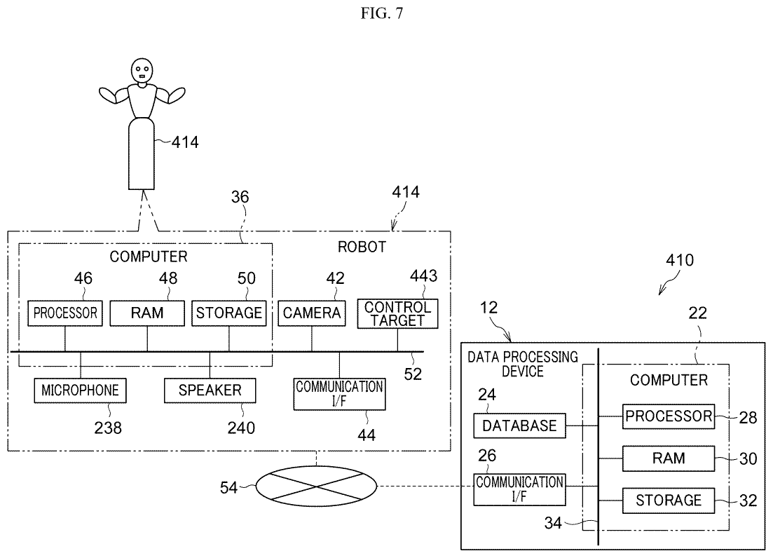

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

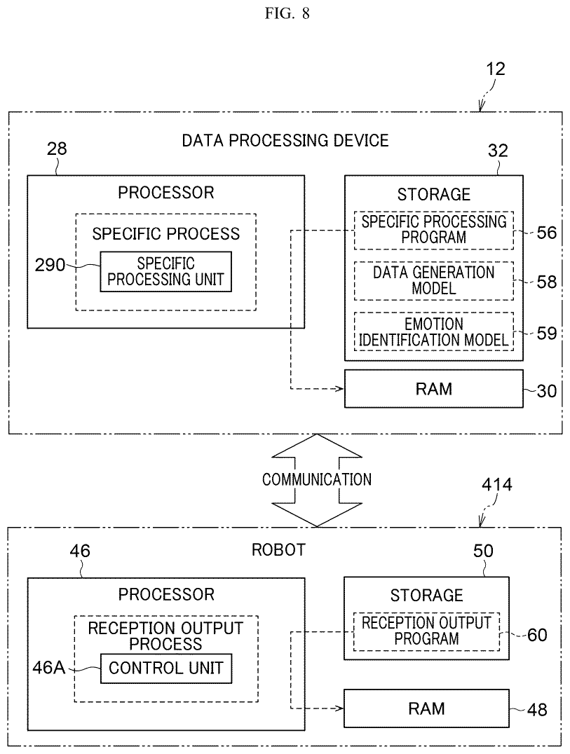

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

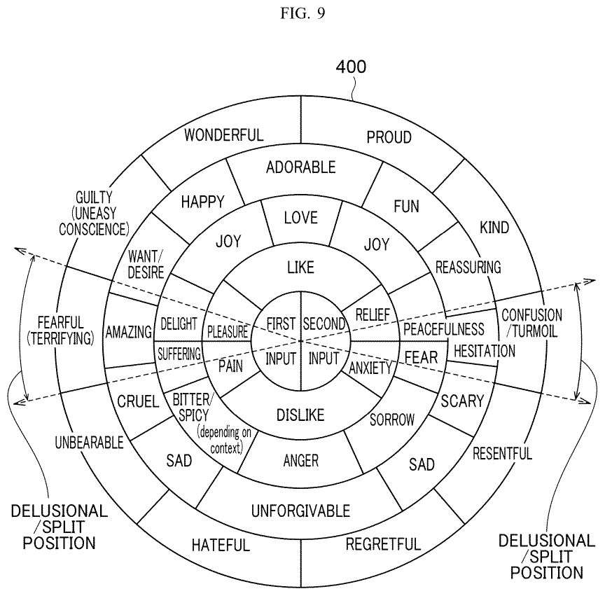

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

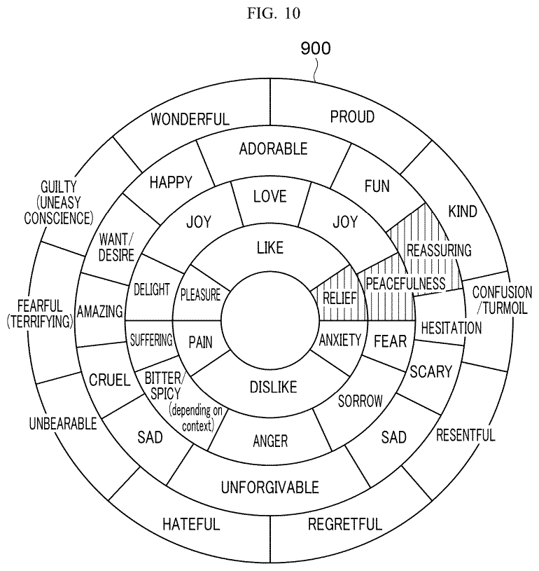

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire character information relating to a suspicious communication received by an elderly person from a terminal, encode the character information, and receive the encoded character information via a communication path as input data,
perform preprocessing on the input data by executing at least character normalization, removal of unnecessary symbols, segmentation into linguistic units, and normalization of word forms, thereby converting the input data into language data in a form suitable for analysis,
generate feature data by executing partial structural analysis and occurrence frequency calculation on the language data, and by extracting, from the language data, words and phrases that are potentially related to fraud as features,
generate a prompt sentence that instructs a generative AI model to evaluate a likelihood of fraud in the suspicious communication, the prompt sentence including at least the language data and the feature data, input the prompt sentence into the generative AI model, and obtain, from the generative AI model, an evaluation result relating to fraud risk and explanatory information relating to the evaluation result,
calculate a numerical index representing the fraud risk based on the evaluation result and the feature data, classify the suspicious communication into one of a plurality of risk categories based on the numerical index, and generate a warning message including warning content for the elderly person based on at least one of the risk category and the explanatory information,
transmit the warning message to the terminal, and cause the terminal to present the warning message to the elderly person via at least one of a display device and an audio output device as a notification, and
acquire feedback information from at least one of the elderly person and a representative via the terminal, store the feedback information in association with at least one of the evaluation result and the numerical index, and update at least one of contents of the prompt sentence and a threshold value of the numerical index based on the feedback information as learning assistance.

### (Supplementary 2)

The system according to supplementary 1,
wherein the processor is configured to
compare the words and the phrases included in the language data with reference information stored in a storage unit defining words and phrases that are potentially related to fraud, thereby generating the feature data including at least keywords, contact information, asset-related expressions, and expressions indicating urgency, and explicitly include the feature data in the prompt sentence to be input to the generative AI model.

### (Supplementary 3)

The system according to supplementary 1,
wherein the processor is configured to
analyze response data obtained from the generative AI model, the response data including the explanatory information and a simplified warning expression for the elderly person, convert the simplified warning expression into a warning message whose wording is adapted to a comprehension level of the elderly person, and cause the terminal to present the warning message to the elderly person in at least one of text display format and audio output format.

### Application Example 1

### (Supplementary 1)

A system comprising a processor,
wherein the processor is configured to receive communication content acquired from a communication terminal and store the communication content as character information,
perform tokenization processing and information extraction processing on the character information by using a natural language processing resource, and obtain feature information including expressions that are potentially related to fraud,
generate a prompt sentence including evaluation instruction content for evaluating a possibility of fraud based on the feature information and the character information, and input the prompt sentence to a generative AI model to obtain evaluation information relating to fraud risk,
calculate a comprehensive fraud risk value by using the evaluation information and the feature information, and determine a danger level classification of the communication content based on the comprehensive fraud risk value,
generate notification information including warning content based on the evaluation information and the feature information when the danger level classification satisfies a predetermined condition, and transmit the notification information to the communication terminal, and
control, at the communication terminal, presentation of a warning to an elderly user via a visual output device or an auditory output device based on the notification information.

### (Supplementary 2)

The system according to supplementary 1,
wherein the processor is configured to
use, as the natural language processing resource, a language analysis program that performs morphological analysis and part-of-speech tagging as the tokenization processing, and performs entity recognition and rule-based pattern matching as the information extraction processing, and extract, as the feature information, at least one of a monetary-related expression, a personal information request expression, an expression indicating urgency or threat, and a network resource reference expression.

### (Supplementary 3)

The system according to supplementary 1,
wherein the processor is configured to
cause the prompt sentence to include, together with input information including the character information and the feature information, instruction content requesting the generative AI model to output a numerical fraud risk index and an explanation of a reason for the numerical fraud risk index, and perform weighted synthesis of the numerical fraud risk index output from the generative AI model and an evaluation value assigned by the rule-based pattern matching in calculating the comprehensive fraud risk value.

### Example 2

### (Supplementary 1)

A system comprising a processor,
wherein the processor is configured to
monitor an operation of an information processing apparatus operated by an elderly user, acquire identification information of a link or information that the elderly user is about to select, and transmit the identification information to an external processing apparatus,
compare the identification information with stored data of known fraudulent links or fraud-related information in a storage apparatus, perform natural language processing on text data associated with the link or information to evaluate a risk level of the link or information, and thereby generate an analysis result indicating safety or danger of the link or information,
when the analysis result indicates that the link or information is high risk, generate a prompt sentence that instructs a generative AI model to generate a warning message, the prompt sentence including at least the analysis result and content of the link or information and requesting the generative AI model to create, in simplified expressions suitable for the elderly user, an explanation of a danger of the link or information and a recommendation to stop access to the link or information,
input the prompt sentence into the generative AI model to cause the generative AI model to generate the warning message, and
transmit the generated warning message to the information processing apparatus so that the warning message is presented to the elderly user visually or audibly by the information processing apparatus.

### (Supplementary 2)

The system according to supplementary 1,
wherein the processor is configured to
obtain text data including at least a subject and a body of communication received by the elderly user, generate a prompt sentence that instructs the generative AI model to analyze the text data and to determine a fraud risk, input the prompt sentence into the generative AI model to extract, from the text data, fraud-related important terms and to obtain a numerical risk indicator representing a likelihood of fraud, and evaluate the safety of the link or information based on the numerical risk indicator.

### (Supplementary 3)

The system according to supplementary 1,
wherein the processor is configured to
integrate a comparison result with the stored data, the numerical risk indicator obtained by the natural language processing, and feature values based on a structure of the link, generate a comprehensive risk evaluation result, and, in accordance with the comprehensive risk evaluation result and attribute information of the elderly user, generate a prompt sentence that instructs the generative AI model to generate the warning message at a linguistic complexity level corresponding to a comprehension level of the elderly user, the prompt sentence including constraint conditions that require the warning message to describe reasons why the link or information is dangerous and specific avoidance actions to be taken by the elderly user.

### Application Example 2

### (Supplementary 1)

A system comprising a processor,
wherein the processor is configured to
perform text preprocessing on communication data and link information acquired from a user terminal by using character string processing functionality and natural language processing functionality to extract text information and link information from the communication data and to generate normalized text information and normalized link information,
obtain evaluation information corresponding to the link information by using an external evaluation functionality in order to evaluate safety of the link information and calculate a risk index regarding the link information based on the evaluation information,
calculate a score indicating a probability of fraud by using a machine learning model based on the text information, the link information, the risk index, and source information in order to integrally evaluate the probability of fraud, and determine a risk level of the communication data based on the score,
generate a first prompt sentence for input to a generative artificial intelligence model by generating summary information that describes in a natural language the text information, the link information, the risk index, and the risk level, input the first prompt sentence to the generative artificial intelligence model, and obtain an evaluation result and explanation information regarding the probability of fraud from the generative artificial intelligence model,
identify an emotional state of a user by analyzing emotion-related information including acoustic information and image information using an emotion analysis functionality, and generate a second prompt sentence that instructs the generative artificial intelligence model to create a user-directed warning message based on the emotional state and the evaluation result, input the second prompt sentence to the generative artificial intelligence model, and obtain an adjusted warning message from the generative artificial intelligence model,
generate notification control information for performing at least one of visual notification and auditory notification to the user terminal based on the adjusted warning message and the risk level, and transmit the notification control information to the user terminal,
generate control information for controlling an access request at the user terminal with respect to link information determined to be high risk in the notification control information, and transmit the control information to the user terminal, and
generate a third prompt sentence including a question sentence input by the user for inquiring to the generative artificial intelligence model and related communication data, input the third prompt sentence to the generative artificial intelligence model when the user inputs the question sentence, and obtain advice information for the user from the generative artificial intelligence model.

### (Supplementary 2)

The system according to supplementary 1,
wherein the processor is configured to store, as record information, preprocessing results for the communication data and the link information, the evaluation information obtained by the external evaluation functionality, the score output by the machine learning model, the prompt sentences input to the generative artificial intelligence model, and the evaluation result output from the generative artificial intelligence model, and periodically execute a learning process to update the machine learning model and structures of the prompt sentences based on the record information.

### (Supplementary 3)

The system according to supplementary 1,
wherein the processor is configured to determine user interface information indicating a display mode and a voice output mode at the user terminal in accordance with the risk level and the emotional state, and generate the notification control information including the user interface information and the warning message and transmit the notification control information to the user terminal.

What is claimed is:

1. A system comprising:
circuitry configured to:
receive, via a communication interface coupled to a packet-switched network, character data representing communication content from a terminal device, and perform preprocessing on the character data comprising character normalization, symbol removal, segmentation into linguistic units, and word-form normalization to generate language data;
execute feature extraction on the language data to generate feature data comprising words and phrases matching a reference pattern set stored in a storage device;
construct a prompt data structure comprising the language data and the feature data, the prompt data structure instructing a generative neural network model to evaluate a risk level of the communication content, transmit the prompt data structure to the generative neural network model, and receive evaluation data comprising a risk assessment and explanatory data;
compute a numerical risk index based on the evaluation data and the feature data, classify the communication content into one of a plurality of risk categories based on the numerical risk index, and generate notification data comprising an alert message based on at least one of the risk category and the explanatory data;
transmit the notification data to the terminal device for presentation via at least one of a display device and an audio output device; and
receive feedback data from the terminal device, store the feedback data in association with the evaluation data and the numerical risk index, and update at least one of a construction parameter of the prompt data structure and a threshold value of the numerical risk index based on the feedback data.

2. The system according to claim 1,
wherein the feature extraction comprises comparing the words and phrases in the language data with the reference pattern set to generate the feature data comprising at least keyword identifiers, contact-information expressions, asset-related expressions, and urgency-indicating expressions, the feature data being explicitly embedded in the prompt data structure.

3. The system according to claim 2,
wherein the circuitry is further configured to analyze response data from the generative neural network model, the response data comprising the explanatory data and a simplified expression component, convert the simplified expression component into the alert message adapted to a comprehension level parameter associated with a user profile stored in the storage device, and cause the terminal device to present the alert message in at least one of a text display format and an audio output format.

4. The system according to claim 1,
wherein the circuitry is further configured to perform tokenization processing and entity recognition processing on the character data using a natural language processing module to obtain the feature data, and perform weighted synthesis of the numerical risk index output from the generative neural network model and an evaluation value computed by rule-based pattern matching to compute a comprehensive risk value.

5. The system according to claim 4,
wherein the circuitry generates the prompt data structure to include instruction content requesting the generative neural network model to output a numerical risk index and an explanation of a basis for the numerical risk index, the comprehensive risk value being computed by integrating the numerical risk index with the evaluation value according to predetermined weights.

6. The system according to claim 1,
wherein the circuitry is further configured to receive, from the terminal device, identification data of a network resource locator and associated text data, compare the identification data with stored data of known malicious resource locators in the storage device and output a comparison result, perform natural language processing on the associated text data to obtain a text-based risk indicator, derive structural feature values based on a domain component and a path component of the network resource locator, and integrate the comparison result, the text-based risk indicator, and the structural feature values to generate a comprehensive risk evaluation result.

7. The system according to claim 6,
wherein the circuitry is further configured to, when the comprehensive risk evaluation result indicates a high-risk classification, construct a prompt data structure comprising the comprehensive risk evaluation result, content of the network resource locator, and constraint conditions specifying that the generative neural network model generate an explanation of reasons for the high-risk classification and avoidance actions, and transmit the prompt data structure to the generative neural network model to obtain the alert message.

8. The system according to claim 7,
wherein the constraint conditions further specify a linguistic complexity level determined based on attribute data of a user profile stored in the storage device, the alert message being generated at the specified linguistic complexity level.

9. The system according to claim 1,
wherein the circuitry is further configured to calculate a score indicating a probability of the communication content being associated with a threat category by using a machine learning model based on the language data, link data extracted from the character data, the numerical risk index, and source identification data, and determine a risk level of the communication content based on the score.

10. The system according to claim 9,
wherein the circuitry generates summary data describing in natural language the language data, the link data, the numerical risk index, and the risk level, constructs the prompt data structure comprising the summary data, and obtains from the generative neural network model an evaluation result and explanation data regarding the probability.

11. The system according to claim 10,
wherein the circuitry is further configured to identify an emotional state of a user by analyzing acoustic data and image data using an emotion analysis model, and generate a second prompt data structure instructing the generative neural network model to create an adjusted alert message based on the emotional state and the evaluation result, the adjusted alert message being transmitted to the terminal device.

12. The system according to claim 11,
wherein the circuitry is further configured to generate access control data for controlling an access request at the terminal device with respect to link data determined to be high risk, and transmit the access control data to the terminal device to restrict access to the high-risk link data.

13. The system according to claim 11,
wherein the circuitry is further configured to receive a question input from the user via the terminal device, construct a third prompt data structure comprising the question input and related communication content data, transmit the third prompt data structure to the generative neural network model, and obtain advisory data for the user from the generative neural network model.

14. The system according to claim 11,
wherein the circuitry determines user interface data indicating a display mode and a voice output mode at the terminal device in accordance with the risk level and the emotional state, and generates the notification data comprising the user interface data and the adjusted alert message.

15. The system according to claim 9,
wherein the circuitry stores, as record data, preprocessing results, evaluation data from the generative neural network model, the score from the machine learning model, and the prompt data structures, and periodically executes a learning process to update the machine learning model and prompt data structure templates based on the record data.

16. The system according to claim 1,
wherein the preprocessing further comprises encoding the character data received from the terminal device into a standardized character encoding format prior to the character normalization, and the segmentation comprises morphological analysis and part-of-speech tagging.

17. The system according to claim 1,
wherein the reference pattern set stored in the storage device comprises pattern entries organized by category including monetary expressions, personal-data request expressions, urgency expressions, and network resource reference expressions, each pattern entry comprising a regular expression or keyword list for matching against the language data.

18. A system comprising:
circuitry configured to:
receive character data representing communication content from a terminal device via a communication interface coupled to a packet-switched network, and perform preprocessing comprising normalization, segmentation, and feature extraction to generate language data and feature data;
construct a prompt data structure comprising the language data and the feature data, and transmit the prompt data structure to a generative neural network model to obtain evaluation data comprising a risk assessment;
compute a numerical risk index from the evaluation data and the feature data, classify the communication content into a risk category, and generate notification data comprising an alert message;
transmit the notification data to the terminal device;
receive identification data of a network resource locator from the terminal device, compare the identification data with stored malicious resource locator data, derive structural feature values from the network resource locator, and integrate comparison results with the risk assessment to generate a comprehensive risk evaluation; and
receive feedback data from the terminal device and update at least one of a prompt construction parameter and a risk threshold based on the feedback data.

19. The system according to claim 18,
wherein the circuitry is further configured to identify an emotional state of a user by analyzing acoustic data and image data, and generate a second prompt data structure to obtain an emotion-adjusted alert message from the generative neural network model.

20. A method comprising:
receiving, by circuitry via a communication interface coupled to a packet-switched network, character data representing communication content from a terminal device, and performing preprocessing on the character data comprising character normalization, symbol removal, segmentation, and word-form normalization to generate language data;
executing feature extraction on the language data to generate feature data comprising words and phrases matching a reference pattern set;
constructing a prompt data structure comprising the language data and the feature data, transmitting the prompt data structure to a generative neural network model, and receiving evaluation data comprising a risk assessment and explanatory data;
computing a numerical risk index based on the evaluation data and the feature data, classifying the communication content into a risk category, and generating notification data comprising an alert message;
transmitting the notification data to the terminal device for presentation via at least one of a display device and an audio output device; and
receiving feedback data from the terminal device and updating at least one of a construction parameter of the prompt data structure and a threshold value of the numerical risk index based on the feedback data.
